(19) United States
(12) Patent Application Publication
(10) Pub. No.: US 2023/0113163 A1
(43) Pub. Date: Apr. 13, 2023

(54) TERMINAL, RADIO COMMUNICATION METHOD, AND BASE STATION

(71) Applicant: NTT DOCOMO, INC., Tokyo (JP)

(72) Inventors: Yuki Takahashi, Tokyo (JP); Satoshi Nagata, Tokyo (JP); Xiaohong Zhang, Beijing (CN); Lihui Wang, Beijing (CN); Xiaolin Hou, Beijing (CN)

(73) Assignee: NTT DOCOMO, INC., Tokyo (JP)

(21) Appl. No.: 17/908,377

(22) PCT Filed: Mar. 6, 2020
(86) PCT No.: PCT/JP2020/009851

§ 371 Date: Aug. 31, 2022

(51) Int. Cl. H04L 1/1812; H04L 1/1829; H04W 72/23

(52) U.S. Cl. CPC H04L 1/1816; H04L 1/1861; H04W 72/23

(57) ABSTRACT

A terminal according to an aspect of the present disclosure includes a transmission section that transmits, when a delivery acknowledgement signal (HARQ-ACK) collides with another UL transmission, the UL transmission, a reception section that receives downlink control information including information related to retransmission of the HARQ-ACK, and a control section that controls retransmission of the HARQ-ACK using a resource notified by the downlink control information.

### TECHNICAL FIELD

The present disclosure relates to a terminal, a radio communication method, and a base station in next-generation mobile communication systems.

### BACKGROUND ART

In a universal mobile telecommunications system (UMTS) network, specifications of long term evolution (LTE) have been drafted for the purpose of further increasing data rates, providing low latency, and the like (Non Patent Literature 1). In addition, the specifications of LTE-Advanced (3GPP Rel. 10 to 14) have been drafted for the purpose of further increasing capacity and advancement of LTE (third generation partnership project (3GPP) Release (Rel.) 8 and 9).

Successor systems to LTE (for example, also referred to as 5th generation mobile communication system (5G), 5G+(plus), New Radio (NR), or 3GPP Rel. 15 or later) are also being studied.

In addition, the existing systems support a configuration in which retransmission in the PDSCH is controlled when a UE feeds back a delivery acknowledgement signal (HARQ-ACK, ACK/NACK, or A/N) for DL data (for example, in PDSCH).

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April, 2010

### SUMMARY OF INVENTION

### Technical Problem

Future radio communication systems (such as 5G or NR) are expected to involve a plurality of traffic types (also referred to as services, types, service types, communication types, or use cases) having different requirements such as higher speed and larger capacity (for example, enhanced mobile broad band (eMBB)), a massive amount of terminals (for example, massive machine type communication (mMTC), internet of things (IoT)), and ultrahigh reliability and low latency (for example, ultra reliable and low latency communications (URLLC)).

In the NR after Rel-16, it is considered that a priority is configured for a given signal (for example, HARQ-ACK) according to a given traffic type or a required condition, and transmission processing or reception processing (for example, processing at the time of collision of a plurality of signals, and the like) is controlled on the basis of the priority.

However, how to control the transmission processing or the reception processing in a case where signals having different priorities (or traffic type) collide has not been sufficiently studied.

Therefore, an object of the present disclosure is to provide a terminal, a radio communication method, and a base station capable of appropriately performing communication even in a case of performing communication using a plurality of traffic types.

### Solution to Problem

According to an aspect of the present disclosure, there is provided a terminal including: a transmission section that transmits, when a delivery acknowledgement signal (HARQ-ACK) collides with another UL transmission, the UL transmission; a reception section that receives downlink control information including information related to retransmission of the HARQ-ACK; and a control section that controls retransmission of the HARQ-ACK using a resource notified by the downlink control information.

### Advantageous Effects of Invention

According to one aspect of the present disclosure, communication can be appropriately performed even when communication is performed using a plurality of traffic types.

### BRIEF DESCRIPTION OF DRAWINGS

FIG. 1 is a diagram illustrating an example of a case where HARQ-ACK feedback is performed for every service type.

FIG. 2 is a diagram illustrating an example of one-shot HARQ-ACK feedback control.

FIG. 3 is a diagram illustrating an example of a case where HARQ-ACKs (or a PUCCH resource) having different priorities collide.

FIG. 4 is a diagram illustrating an example of retransmission control of HARQ-ACK according to a first aspect.

FIG. 5 is a diagram illustrating another example of the retransmission control of HARQ-ACK according to the first aspect.

FIG. 6 is a diagram illustrating an example of retransmission control of HARQ-ACK according to a second aspect.

FIG. 7 is a diagram illustrating another example of the retransmission control of HARQ-ACK according to the second aspect.

FIG. 8 is a diagram illustrating an example of retransmission control of HARQ-ACK according to a third aspect.

FIG. 9 is a diagram illustrating an example of retransmission control of HARQ-ACK according to a fourth aspect.

FIG. 10 is a diagram illustrating an example of a schematic configuration of a radio communication system according to one embodiment.

FIG. 11 is a diagram illustrating an example of a configuration of a base station according to one embodiment.

FIG. 12 is a diagram illustrating an example of a configuration of a user terminal according to one embodiment.

FIG. 13 is a diagram illustrating an example of a hardware configuration of the base station and the user terminal according to one embodiment.

### DESCRIPTION OF EMBODIMENTS

<Service (Traffic Type)>

Future radio communication systems (for example, NR) are expected to involve traffic types (also referred to as types, services, service types, communication types, or use cases) such as an enhanced mobile broadband (eMBB), machine type communications that embody multiple simultaneous connection (for example, massive machine type communications (mMTC), Internet of Things (IoT), and ultra-reliable and low-latency communications (URLLC). For example, it is required that URLLC have smaller latency and higher reliability than eMBB.

The traffic type may be identified in a physical layer on the basis of at least one of the following.

Logical channels with different priorities

Modulation and coding scheme (MCS) table (MCS index table)

Channel quality indication (CQI) table

DCI format

System information-radio network temporary identifier (RNTI) used for scrambling (masking) of cyclic redundancy check (CRC) bit included in (added to) the DCI (DCI format)

Radio resource control (RRC) parameter

Specific RNTI (for example, RNTI for URLLC, MCS-C-RNTI, or the like)

Search Space

Given field in DCI (for example, newly added field or reuse of existing field)

Specifically, a traffic type of HARQ-ACK for a PDSCH (or PUCCH) may be determined on the basis of at least one of the followings.

MCS index table used to determine at least one of the modulation order, target code rate, and transport block size (TBS) of the PDSCH (for example, whether to use MCS index table 3)

RNTI used for CRC scrambling of DCI used for scheduling the PDSCH (for example, whether CRC scrambled with C-RNTI or MCS-C-RNTI)

Priority that is configured by higher layer signaling

The traffic type may be associated with communication requirements (requirements and required conditions such as latency and error rate), a data type (voice, data, and the like), or the like.

A difference between URLLC requirements and eMBB requirements may be that URLLC is lower in latency than eMBB or that URLLC requirements include reliability requirements.

For example, eMBB user (U)-plane latency requirements may include that downlink U-plane latency is 4 ms and that uplink U-plane latency is 4 ms. Meanwhile, URLLC U-plane latency requirements may include that downlink U-plane latency is 0.5 ms and that uplink U-plane latency is 0.5 ms. Furthermore, the URLLC reliability requirements may include that a 32-byte error rate is 10⁻⁵ for a U-plane latency of 1 ms.

In contrast, enhancement of the reliability of traffic for unicast data is mainly studied as enhanced ultra reliable and low latency communications (eURLLC). Hereinafter, in a case where URLLC and eURLLC are not distinguished, they are simply referred to as URLLC.

(HARQ-ACK Codebook)

The UE may transmit hybrid automatic repeat request acknowledgement (HARQ-ACK) feedback by using one PUCCH resource for every HARQ-ACK codebook including one or more delivery acknowledgement information (for example, HARQ-ACK) bits. The HARQ-ACK bits may be referred to as HARQ-ACK information, HARQ-ACK information bits, or the like.

Here, the HARQ-ACK codebook may include bits for the HARQ-ACKs in at least one unit of a time domain (for example, a slot), a frequency domain (for example, component carrier (CC)), a spatial domain (for example, a layer), a transport block (TB), and a code block group (CBG) constituting the TB. The HARQ-ACK codebook may be simply referred to as a codebook.

Note that the number (size) of bits included in the HARQ-ACK codebook or the like may be determined in a semi-static or dynamic manner. The HARQ-ACK codebook of which the size is determined semi-statically is also referred to as, for example, a semi-static HARQ-ACK codebook or a type-1 HARQ-ACK codebook. The HARQ-ACK codebook of which the size is determined dynamically is also referred to as, for example, a dynamic HARQ-ACK codebook or a type-2 HARQ-ACK codebook.

Which one of the type-1 HARQ-ACK codebook and the type-2 HARQ-ACK codebook is to be used may be configured in the UE by using a higher layer parameter (for example, pdsch-HARQ-ACK-codebook).

For the type-1 HARQ-ACK codebook, the UE may feed back, in a given range (for example, a range configured on the basis of the higher layer parameter), the HARQ-ACK bit for a candidate PDSCH (or PDSCH occasion) corresponding to the given range, regardless of whether or not there is PDSCH scheduling.

The given range may be determined on the basis of at least one of a given period (for example, a set of a given number of occasions for receiving the candidate PDSCH or a given number of monitoring occasions of the PDCCH), the number of CCs configured or activated in the UE, the number of TBs (layer number or rank), the number of CBGs per one TB, or the presence or absence of application of spatial bundling. The given range is also referred to as a HARQ-ACK window, a HARQ-ACK bundling window, a HARQ-ACK feedback window, and the like.

In the type-1 HARQ-ACK codebook, the UE reserves the HARQ-ACK bit for the PDSCH in the codebook if they are within the given range even in a case where the PDSCH is not scheduled for the UE. In a case where it is determined that the PDSCH is not actually scheduled, the UE can feed back the bit as a NACK bit.

Meanwhile, in a case of the type-2 HARQ-ACK codebook, the UE may feed back the HARQ-ACK bit for the PDSCH that is scheduled within the given range.

Specifically, the UE may determine the number of bits of the type-2 HARQ-ACK codebook on the basis of a given field (for example, a downlink assignment indicator (index) (DAI) field) in the DCI. Note that the DAI field may include a counter DAI (C-DAI) and a total DAI (T-DAI).

The C-DAI may indicate a counter value of downlink transmission (PDSCH, data, and TB) scheduled within a given period. For example, the C-DAI in the DCI for scheduling data within the given period may indicate the number counted in the frequency domain (for example, the CC) first and then in the time domain within the given period. For example, the C-DAI may correspond to a value obtained by counting the number of PDSCH receptions or SPS releases in ascending order of a serving cell index and then in ascending order of a PDCCH monitoring occasion for one or more DCIs included in the given period.

The T-DAI may indicate a total value (total number) of data scheduled within the given period. For example, the T-DAI in the DCI for scheduling data in a given time unit (for example, the PDCCH monitoring occasion) within the given period may indicate the total number of data scheduled up to the time unit (also referred to as a point, a timing, or the like) within the given period.

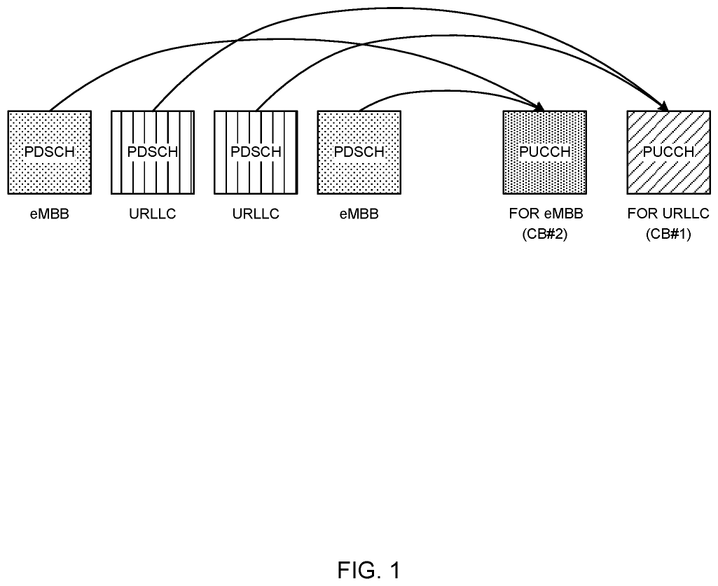

It is also studied that HARQ-ACK codebooks are separately configured for different service types (or, PDSCHs or HARQ-ACKs to which different priorities are configured) (refer to FIG. 1). That is, it is conceivable that a plurality of HARQ-ACK codebooks are simultaneously configured to support a plurality of service types (or a plurality of priorities). For example, a first HARQ-ACK codebook (CB #1) corresponding to URLLC (for example, a first priority) and a second HARQ-ACK codebook (CB #2) corresponding to eMBB (for example, a second priority) may be configured.

In this case, a first PUCCH configuration parameter (for example, PUCCH configuration or PUCH configuration parameters) corresponding to the first HARQ-ACK codebook and a second PUCCH configuration parameter corresponding to the second HARQ-ACK codebook may be separately supported or configured. The PUCCH configuration parameter may be at least one of a PUCCH resource (or a PUCCH resource set) applied to transmission of the HARQ-ACK, PUCCH transmission timing (for example, K1 set), a maximum code rate (for example, a max-code rate), and PUCCH transmission power.

In this case, first PUCCH configuration information may be applied to HARQ-ACK feedback for URLLC, and second PUCCH configuration information may be applied to HARQ-ACK feedback for eMBB.

<HARQ Process>

For a UE in which carrier aggregation (CA) or dual connectivity (DC) is configured, there may be one independent HARQ entity for each cell (CC) or each cell group (CG). The HARQ entity may manage a plurality of HARQ processes in parallel.

In a radio communication system, data transmission is based on scheduling, and scheduling information for downlink (DL) data transmission is carried in downlink control information (DCI). FIG. 1 is a diagram illustrating a relationship among HARQ entities, a HARQ process, and DCI. A HARQ process number (HPN) is given to a HARQ process. The DCI includes a 4-bit HARQ process number field indicating the HARQ process number used for the current data transmission. The HARQ entity manages a plurality (up to 16) of HARQ processes in parallel. That is, as HARQ process numbers, there are HPN0 to HPN15. A HARQ process number is also referred to as a HARQ process ID (HARQ process identifier).

A unit of transmitting uplink (UL) data by a physical uplink shared channel (PUSCH) and a unit of transmitting DL data by a physical downlink shared channel (PDSCH) may be referred to as a transport block (TB). The TB is a unit handled by a media access control (MAC) layer. The control of HARQ (retransmission) may be performed for each TB or may be performed for each code block group (CBG) including one or more code blocks (CBs) in a TB.

A user terminal transmits information indicating positive acknowledgement (ACK)/negative acknowledgement(NACK) of HARQ, which indicates whether or not decoding of a DL transport block having received using the PDSCH is successful, to a base station using a physical uplink control channel (PUCCH), a PUSCH, or the like.

In a case where a plurality of UL data or a plurality of DL data is not spatially multiplexed in a physical layer, a single HARQ process corresponds to one transport block (TB). In a case where a plurality of UL data or a plurality of DL data is spatially multiplexed in the physical layer, a single HARQ process may correspond to one or more transport blocks (TBs).

<One-Shot HARQ-ACK Feedback>

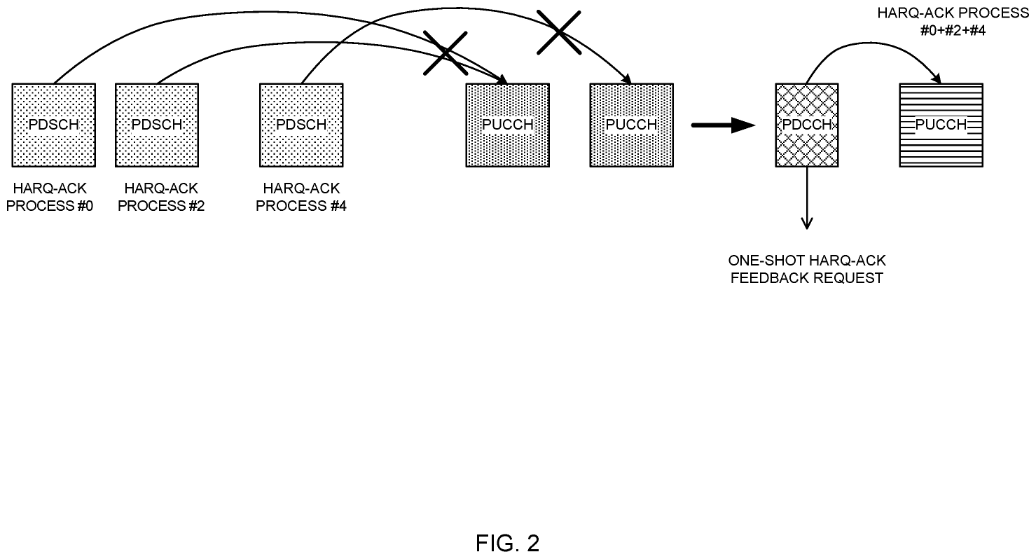

In Rel. 16 and later, it is studied to request or trigger feedback of a HARQ-ACK codebook including all HARQ-ACK processes to the UE in order to provide a transmission opportunity for HARQ-ACK feedback due to an LBT failure at the UE or misdetection of the PUCCH at the base station (refer to FIG. 2). The HARQ-ACK processes (for example, DL HARQ-ACK processes) may be HARQ-ACKs on all CCs configured for the UE in the PUCCH group.

Illustrated in FIG. 2 is a case where HARQ-ACK processes #0, #2, and #4 are fed back in response to a request for one-shot HARQ-ACK feedback.

The feedback of HARQ-ACK (or a HARQ-ACK codebook) including all HARQ-ACK processes on all CCs may be referred to as one-shot HARQ-ACK feedback. Notification of the one-shot HARQ-ACK feedback may be provided from the base station to the UE by using a given DCI format. The given DCI format may be a UE-specific DCI format (for example, DCI format 1_1).

The UE that has been requested or triggered of the one-shot HARQ-ACK feedback may feed back, using the PUCCH, a codebook including a plurality of (for example, all) HARQ-ACK processes in the respective CCs that have been configured.

In this manner, it is assumed that one-shot HARQ-ACK feedback is introduced. The one-shot HARQ-ACK feedback may be referred to as one-time HARQ-ACK feedback, a single HARQ-ACK feedback, one-shot HARQ-ACK, or the like.

<Priority Configuration>

In the NR after Rel. 16, configuring priorities at a plurality of levels (for example, two levels) for a given signal or channel is being studied. For example, it is assumed that communication is controlled (for example, transmission control at the time of collision, and the like) by configuring different priorities for every signal or channel each corresponding to different traffic types (also referred to as services, service types, communication types, use cases, and the like). This makes it possible to control communication by configuring, for the same signal or channel, different priorities depending on a service type or the like.

The priority may be configured for a signal (for example, UCI such as HARQ-ACK and a reference signal), a channel (PDSCH, PUSCH, or the like), a HARQ-ACK codebook, or the like. The priority may be defined by a first priority (for example, High) and a second priority (for example, Low) that is lower than the first priority. Alternatively, three or more types of priorities may be configured. Notification of the information about the priority may be provided from a base station to the UE by using at least one of higher layer signaling and DCI.

For example, priorities may be configured for HARQ-ACK for PDSCH that is dynamically scheduled, HARQ-ACK for semi-persistent PDSCH (SPS PDSCH), and HARQ-ACK for SPS PDSCH release. Alternatively, priorities may be configured for HARQ-ACK codebooks corresponding to these HARQ-ACKs. Note that, in a case where a priority is configured to the PDSCH, the priority of the PDSCH may be read as interchangeable with the priority of HARQ-ACK for the PDSCH.

The UE may control UL transmission on the basis of the priorities in a case where different UL signals or UL channels collide with each other. For example, control may be performed so that UL transmission with high priority is performed and that UL transmission with low priority is not performed (for example, to drop).

The different UL signals/UL channels colliding with each other may be a case where resources respectively corresponding to the different UL signals/UL channels overlap, or a case where transmission timings of the different UL signals/UL channels overlap. The resource may be, for example, a time resource, or a time resource and a frequency resource.

In a case where notification of the priorities is provided using the DCI, whether or not a bit field (for example, priority indicator) for providing notification of the priority to the DCI is configured may be provided in notification or configured from a base station to the UE using higher layer signaling. In addition, in a case where no bit field for providing notification of the priority to the DCI is included, the UE may determine that the priority of the PDSCH (or HARQ-ACK corresponding to the PDSCH) scheduled by the DCI is a specific priority (for example, low).

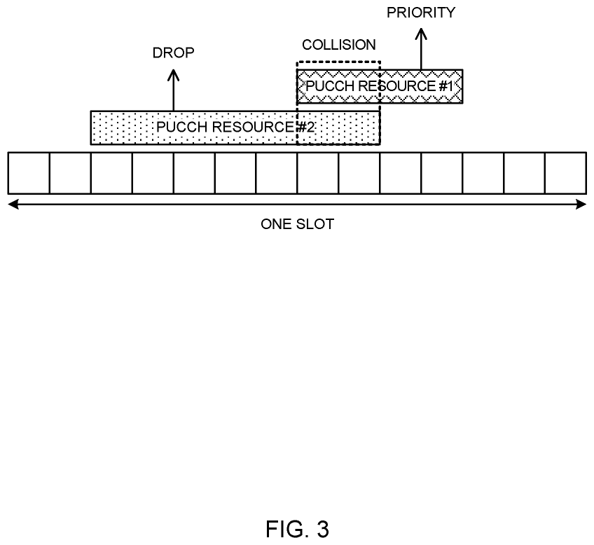

As described above, in a case where the UL transmission is controlled on the basis of the priority, there is a possibility that throughput is reduced by not performing (for example, drop) the UL transmission with a low priority. For example, it is assumed that a first resource corresponding to a first HARQ-ACK collides with a second resource corresponding to a second HARQ-ACK having a lower priority than the first HARQ-ACK (refer to FIG. 3).

In this case, it is conceivable that the UE transmits the first HARQ-ACK by using the first resource, and controls not to transmit the second HARQ-ACK (for example, drop).

When the second HARQ-ACK having a low priority is dropped, the DL transmission (for example, PDSCH) corresponding to the second HARQ-ACK is retransmitted, and it is necessary to feed back the HARQ-ACK to the retransmitted PDSCH (for example, eMBB) again. As a result, a throughput of a traffic type (for example, eMBB) having a low priority may be reduced.

In order to suppress a decrease in throughput, it is conceivable to retransmit the dropped HARQ-ACK (second HARQ-ACK in FIG. 3). However, how to control the retransmission of the dropped HARQ-ACK is a problem.

The present inventors have studied how to control transmission of a plurality of HARQ-ACKs in a case where transmission processing or feedback processing is controlled according to a traffic type (or priority) in a case where the plurality of HARQ-ACKs collide, and have conceived the present embodiment.

Hereinafter, embodiments according to the present disclosure will be described in detail with reference to the drawings. The following aspects may be applied independently or may be applied in combination. In the following description, NB may be read as interchangeable with at least one of A and B, and A/B/C may be read as interchangeable with at least one of A, B, and C.

In addition, in the following description, a first priority (High) and a second priority (Low) will be described as examples of priorities, however, the number and type of the priorities are not limited thereto. Three or more types (or three or more levels) of priorities may be applied. Furthermore, a priority configured to each signal or channel may be configured in a UE by higher layer signaling or the like.

In the following description, two service types of eMBB and URLLC will be described as examples of a plurality of service types, however, the types and the number of service types are not limited thereto. In addition, a service type may be configured in association with the priority. Furthermore, in the following description, the drop may be read as interchangeable with cancellation or non-transmission.

In addition, in the following description, the HARQ-ACK will be described as an example of a signal to be retransmitted, but the signal/channel to which the present embodiment can be applied is not limited to the HARQ-ACK. The present embodiment may be applied to other signals/channels.

(First Aspect)

In the first aspect, a case where the retransmission instruction (or request/trigger) of the HARQ-ACK is controlled using the DL data (for example, DL-SCH) or the DCI in which the PDSCH is not scheduled will be described. In the following description, a case where the PDSCH is not scheduled by the DCI will be described as an example.

When receiving the DCI (or PDCCH) instructing retransmission of the given HARQ-ACK, the UE may control to retransmit (or retransmission, feedback, transmission) the given HARQ-ACK on the basis of the DCI. The given HARQ-ACK may be a HARQ-ACK that has not been transmitted due to a collision with another UL transmission (for example, dropped or transmission stalled).

The DCI (hereinafter, it is also referred to as request DCI) instructing retransmission of the given HARQ-ACK may be DCI that does not schedule the PDSCH. The request DCI may be UE specific (for example, specific or dedicated), and for example, at least one of DCI format 1_1 and DCI format 1_2 may be used. In addition, the request DCI may be configured not to schedule/instruct a channel state information reference signal (for example, CSI-RS)/channel state information report (for example, A-CSI report) in addition to the configuration not to schedule the PDSCH (or, the PDSCH is not scheduled).

The UE may determine whether the received DCI is the request DCI based on a given field included in the DCI. For example, it may be configured such that a field (for example, requestHarqReTx) about a retransmission request of the HARQ-ACK is configured to DCI, and in a case where a bit of the field is “1”, the request DCI functions, and in a case where the bit is “0”, the request DCI does not function. Alternatively, notification of whether or not the received DCI is the request DCI may be provided using another field. Alternatively, notification of whether or not the received DCI is the request DCI may be provided by using the RNTI applied to the DCI.

When receiving the request DCI, the UE may retransmit a given HARQ-ACK using a given resource. The resource used for retransmission of the HARQ-ACK may be a new resource that is at least partially different (or only a part thereof is the same) from the resource configured for transmission of the dropped HARQ-ACK (hereinafter, also referred to as original HARQ-ACK). The resource may be read as interchangeable with a PUCCH resource.

The new resource used for retransmission of the HARQ-ACK may be determined on the basis of at least one of information (for example, K1) about the HARQ-ACK timing included in the request DCI and a PUCCH resource identifier (PUCCH Resource Indicator (PRI)) field.

For example, it is assumed that a first resource corresponding to a first HARQ-ACK collides with a second resource corresponding to a second HARQ-ACK having a lower priority than the first HARQ-ACK.

The first HARQ-ACK corresponds to a first PDSCH scheduled in the first DCI, and the first resource may be designated by the first DCI (and higher layer signaling). The second HARQ-ACK corresponds to a second PDSCH scheduled in the second DCI, and the second resource may be designated by the second DCI (and higher layer signaling). Notification of the priority of the first HARQ-ACK may be provided in the first DCI, and notification of the priority of the second HARQ-ACK may be provided in the second DCI.

In such a case, the UE may control to transmit the first HARQ-ACK by using the first resource and not transmit the second HARQ-ACK (or, the HARQ-ACK transmission using the second resource is not performed). When receiving a request DCI (for example, the third DCI) instructing retransmission of the HARQ-ACK, the UE may perform control to transmit the second HARQ-ACK using a resource designated by the request DCI.

Note that there may be a plurality of dropped HARQ-ACKs. The UE may determine HARQ-ACK (for example, the dropped second HARQ-ACK) for performing retransmission based on the request DCI based on at least one of the following Option 1-1 to Option 1-3.

<Option 1-1>

The UE may control to feed back a plurality of HARQ-ACKs (for example, multiple HARQ-ACKs with low priority) based on the request DCI instructing retransmission of the HARQ-ACK. For example, the base station may request (or a trigger) feedback of the one-shot HARQ-ACK to the UE by using the request DCI. That is, the HARQ-ACK bit requested to be retransmitted in the request DCI may be a DL HARQ-ACK process in all CCs configured in the UE in a given group (for example, a PUCCH group).

The UE requested to feed back the one-shot HARQ-ACK by the request DCI may include one or more HARQ-ACKs in one (or common) HARQ-ACK codebook to perform the feedback. The HARQ-ACK to be included in one HARQ-ACK codebook may be a HARQ-ACK corresponding to a given HARQ-ACK process (or a given HARQ-ACK process number).

The given HARQ-ACK process may be, for example, a HARQ-ACK process corresponding to a PDSCH scheduled for the UE. Furthermore, in a case where a plurality of CCs (or cells) is configured in the UE, HARQ-ACKs corresponding to HARQ-ACK processes in the plurality of CCs may be included in one HARQ-ACK codebook.

As a result, in a case where there is a plurality of dropped HARQ-ACKs (for example, a plurality of second HARQ-ACKs having different transmission timings are dropped), retransmission can be performed on the basis of one request DCI. As a result, a decrease in throughput can be suppressed.

<Option 1-2>

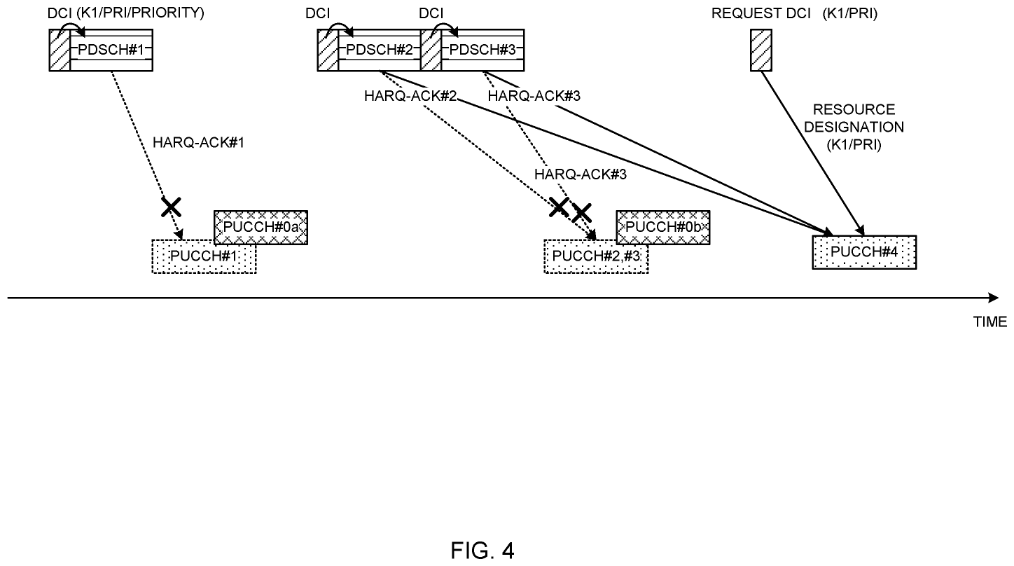

The UE may control to feed back (for example, retransmission) the HARQ-ACK dropped most recently (for example, latest) based on the request DCI (refer to FIG. 4). That is, when there is a plurality of HARQ-ACKs that have not been transmitted, the UE performs control to retransmit HARQ-ACKs that have not been transmitted last (or, the last dropped HARQ-ACK).

FIG. 4 illustrates a case where the HARQ-ACK #1 (or PUCCH resource #1) corresponding to the PDSCH #1 collides with another UL transmission (for example, the URLLC PUCCH resource #0a) having a high priority and is dropped.

In addition, a case where the HARQ-ACK #2 (or PUCCH resource #2) corresponding to the PDSCH #2 and the HARQ-ACK #3 (or PUCCH resource #3) corresponding to the PDSCH #3 collide with another UL transmission (for example, the URLLC PUCCH resource #0b) having a high priority and are dropped is illustrated. Here, a case where the PUCCH resource #2 and the PUCCH resource #3 are the same PUCCH resource (or, PUCCH resources configured in the same slot) is illustrated.

FIG. 4 illustrates a case where the request DCI is transmitted after the HARQ-ACKs #2 and #3 are dropped. That is, after the HARQ-ACK #1 is dropped, the HARQ-ACKs #2 and #3 are dropped before the request DCI is transmitted.

As described above, when the UE receives the request DCI, in a case where there is a plurality of dropped HARQ-ACKs, control may be performed such that the last dropped HARQ-ACK (or, the HARQ-ACK corresponding to the last PUCCH resource that has not been used for transmission) is retransmitted.

The HARQ-ACK to be retransmitted may be determined in units of PUCCH resources. That is, when the HARQ-ACKs corresponding to the same PUCCH resource (or, PUCCH resources configured in the same slot) are dropped (HARQ-ACKs #2 and #3 in FIG. 4), the plurality of HARQ-ACKs may be controlled to be retransmitted.

Here, since the HARQ-ACKs #2 and #3 correspond to the last dropped PUCCH resource, the UE may perform control to retransmit the HARQ-ACKs #2 and #3 using the resource designated by the request DCI. The resource (for example, here, a PUCCH resource #4) designated by the request DCI may be determined on the basis of at least one of information (for example, K1) about the HARQ-ACK timing included in the request DCI and a PUCCH resource identifier (PUCCH Resource Indicator (PRI)) field.

When retransmitting the HARQ-ACK, the UE may use a resource condition (for example, PRI) configured for the dropped HARQ-ACK (for example, the original HARQ-ACK). For example, the UE may determine the retransmission timing of the HARQ-ACK (for example, a retransmission slot) on the basis of the information (for example, K1) about the HARQ-ACK timing included in the request DCI, and determine the resource to be used for retransmission of the HARQ-ACK on the basis of a PRI (for example, the PRI notification of which is provided by the DCI for scheduling the PDSCH) that has already been designated. In this case, the PRI may not be included in the request DCI. Alternatively, the UE may ignore the PRI field included in the request DCI. As a result, an increase in the overhead of the request DCI can be suppressed.

The last dropped HARQ-ACK (or a PUCCH resource) may be determined based on the timing at which the HARQ-ACK is transmitted (or a time domain in which a PUCCH resource is configured). Alternatively, the determination may be made on the basis of the transmission timing of the DCI or the transmission timing of the PDSCH corresponding to the HARQ-ACK (or a PUCCH resource).

In Option 1-2, it is possible to flexibly control the HARQ-ACK to perform retransmission on the basis of the transmission timing of the request DCI. As a result, an increase in the overhead of the retransmitted HARQ-ACK can be suppressed, and a decrease in the throughput can be suppressed.

<Option 1-3>

The UE may determine the HARQ-ACK to perform retransmission based on the information notification of which is provided from the base station. The information notification of which is provided from the base station may be at least one of DCI and higher layer signaling.

<Notification by DCI>

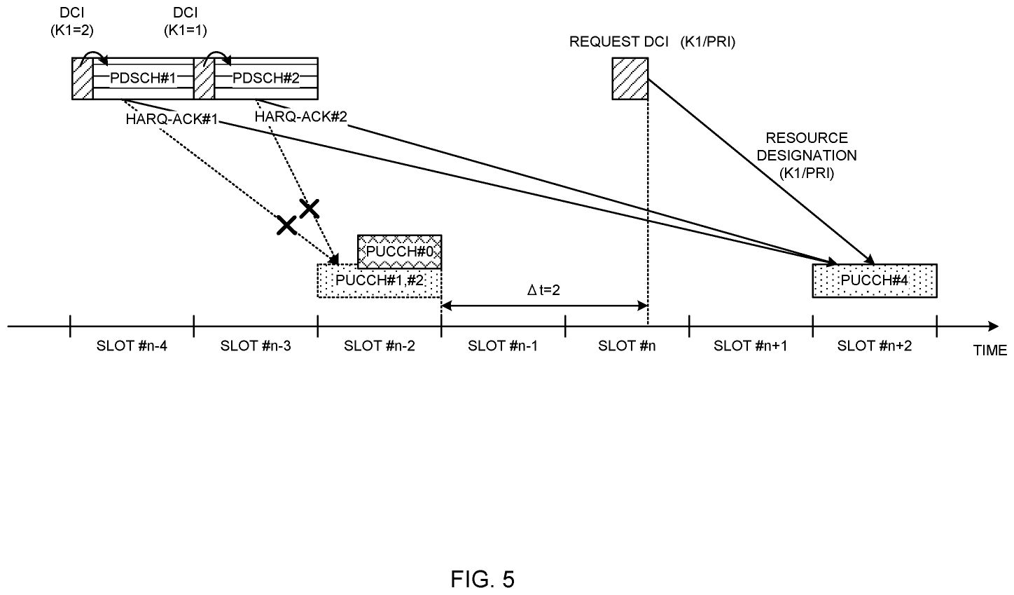

The UE may determine the HARQ-ACK to perform retransmission based on the request DCI instructing retransmission of the HARQ-ACK (refer to FIG. 5). For example, information designating the original HARQ-ACK (original HARQ-ACK) of the HARQ-ACK to be retransmitted may be included in the request DCI. In the following description, a case will be described in which information about the offset between the request DCI and the original HARQ-ACK (or an original PUCCH resource) is included in the request DCI and provided in notification to the UE.

FIG. 5 illustrates a case where the HARQ-ACK #1 (or PUCCH resource #1) corresponding to the PDSCH #1 and the HARQ-ACK #2 (or PUCCH resource #2) corresponding to the PDSCH #2 collide with another UL transmission (for example, a URLLC PUCCH resource #0) having a high priority and are dropped. Here, a case where the PUCCH resource #1 and the PUCCH resource #2 are the same PUCCH resource (or, a PUCCH resource configured in the same slot #n-2) is illustrated.

When receiving the request DCI, the UE may perform control to retransmit the HARQ-ACK designated by the request DCI. For example, a time interval (for example, the index m) in which HARQ-ACK (or dropped HARQ-ACK) to be retransmitted is scheduled to be transmitted may be designated by the request DCI. The time interval may be at least one of a slot, a subslot, or a symbol.

The request DCI may include an offset between the request DCI and the dropped HARQ-ACK (or a PUCCH resource). The offset may be referred to as a timing offset (for example, Δt). The UE may determine the HARQ-ACK (or original HARQ-ACK) to perform retransmission based on the timing offset included in the request DCI.

FIG. 5 illustrates a case where the timing offset included in the request DCI transmitted in the slot #n is 2 (Δt=2). In this case, the UE may control to retransmit HARQ-ACK (here, HARQ-ACKs #1 and #2) in the slot m (=n-2). Further, the retransmission of the HARQ-ACK may use a resource (here, a PUCCH resource #4) designated by the request DCI.

The timing offset (for example, At) may be configured in a new field of the request DCI (for example, DCI format 1_1 or 1_2), or may be configured in an existing field (for example, a time allocation field (TDRA field)).

Here, the case where notification of the interval between the slot in which the request DCI (or PDCCH) is transmitted and the slot in which the original HARQ-ACK is transmitted is provided using the timing offset value included in the request DCI has been described, but the present invention is not limited thereto. For example, information (for example, a process number or a slot number) about the HARQ-ACK requesting retransmission may be included in the request DCI and provided in notification to the UE.

<Notification by Higher Layer>

The UE may determine the HARQ-ACK to perform retransmission on the basis of the information about the timing offset notification of which is provided in the higher layer. The timing offset (for example, Δt) may be an interval between a slot to which the request DCI (or PDCCH) is transmitted and a slot to which the original HARQ-ACK is transmitted.

When receiving the request DCI instructing retransmission of the HARQ-ACK in the slot n, the UE may perform control to retransmit the HARQ-ACK in the slot n-Δt.

### [Notification by Combination of DCI and Higher Layer]

The base station may configure a plurality of timing offset values (candidate values) for the UE in higher layer signaling, and notify the UE of the specific candidate values by using DCI (for example, the request DCI). As a result, the timing offset can be flexibly configured.

When notification of the timing offset is not provided by the DCI or higher layer signaling, the UE may determine HARQ-ACK (or original HARQ-ACK) to retransmit based on a preset value (for example, a default value).

<Variations>

When retransmission of the HARQ-ACK is instructed based on the request DCI, the same priority as the original HARQ-ACK (dropped HARQ-ACK) may be configured as the priority of the HARQ-ACK to be retransmitted, or a different priority may be configured.

In a case where the same priority is configured to the original HARQ-ACK and the HARQ-ACK to be retransmitted, the information (for example, PriorityIndicator) field about the priority may not be included in the request DCI. As a result, an increase in the overhead of the request DCI can be suppressed.

Alternatively, in a case where retransmission of the HARQ-ACK is instructed on the basis of the request DCI, the priority of the HARQ-ACK to be retransmitted may be configured to be high. For example, even when the priority of the original HARQ-ACK (dropped HARQ-ACK) is low, in a case where the dropped HARQ-ACK is retransmitted, a high priority (for example, high) may be configured. A higher priority (high) may be configured for the request DCI, or the priority of the HARQ-ACK retransmitted on the UE side without including the information about the priority in the request DCI may be assumed to be high. As a result, the retransmission of the HARQ-ACK can be preferentially performed.

(Second Aspect)

In the second aspect, a case will be described in which the retransmission instruction (or request/trigger) of the HARQ-ACK is controlled using the DL data (for example, DL-SCH) or the DCI for scheduling the PDSCH.

The request DCI may be DCI for scheduling the PDSCH. The request DCI may be UE specific (for example, specific or dedicated), and for example, at least one of DCI format 1_1 and DCI format 1_2 may be used. In addition, the request DCI may be configured to schedule/instruct a channel state information reference signal (for example, CSI-RS)/channel state information report (for example, A-CSI report) in addition to the configuration to schedule the PDSCH (or, in place of the configuration for scheduling the PDSCH,).

The UE may determine whether the received DCI is the request DCI based on a given field included in the DCI. For example, it may be configured such that a field (for example, requestHarqReTx) about a retransmission request of the HARQ-ACK is configured to DCI, and in a case where a bit of the field is “1”, the request DCI functions, and in a case where the bit is “0”, the request DCI does not function. Alternatively, notification of whether or not the received DCI is the request DCI may be provided using another field. Alternatively, notification of whether or not the received DCI is the request DCI may be provided by using the RNTI applied to the DCI.

When receiving the request DCI, the UE may retransmit a given HARQ-ACK using a given resource. The new resource used for retransmission of the HARQ-ACK may be determined on the basis of at least one of information (for example, K1) about the HARQ-ACK timing included in the request DCI and a PUCCH resource identifier (PUCCH Resource Indicator (PRI)) field.

For example, it is assumed that a first resource corresponding to a first HARQ-ACK collides with a second resource corresponding to a second HARQ-ACK having a lower priority than the first HARQ-ACK.

The first HARQ-ACK corresponds to a first PDSCH scheduled in the first DCI, and the first resource may be designated by the first DCI (and higher layer signaling). The second HARQ-ACK corresponds to a second PDSCH scheduled in the second DCI, and the second resource may be designated by the second DCI (and higher layer signaling). Notification of the priority of the first HARQ-ACK may be provided in the first DCI, and notification of the priority of the second HARQ-ACK may be provided in the second DCI.

In such a case, the UE may control to transmit the first HARQ-ACK by using the first resource and not transmit the second HARQ-ACK (or, the HARQ-ACK transmission using the second resource is not performed). When receiving a request DCI (for example, the third DCI) instructing retransmission of the HARQ-ACK, the UE may perform control to transmit the second HARQ-ACK using a resource designated by the request DCI.

In addition, the UE controls reception of the PDSCH scheduled in the request DCI. The HARQ-ACK for the PDSCH scheduled by the request DCI may be configured to be transmitted using a given resource, or may be configured not to be transmitted. For example, the UE may apply at least one of the following Options 2-1 to 2-2 to the HARQ-ACK for the PDSCH scheduled in the request DCI.

<Option 2-1>

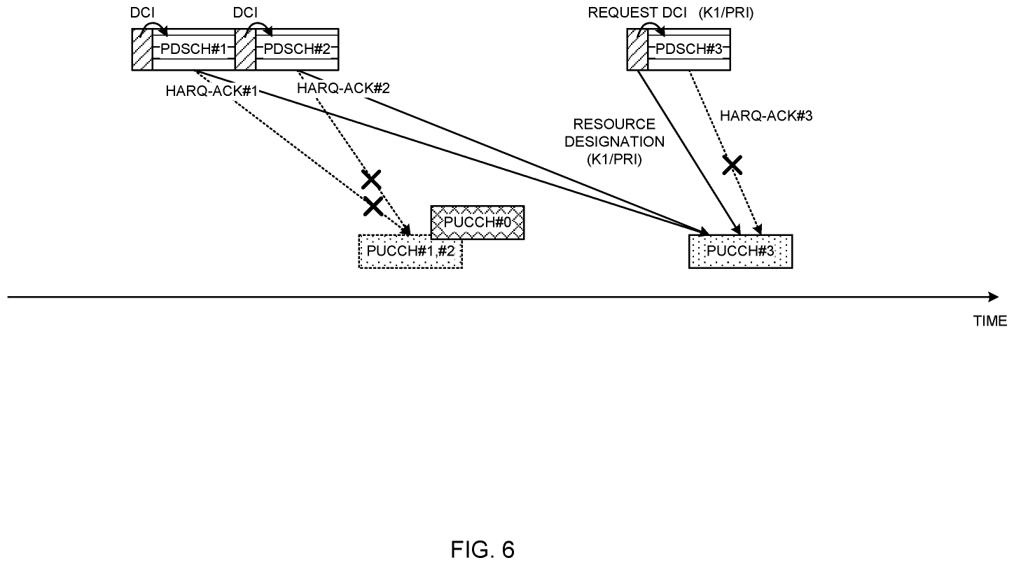

The UE may use the resource designated by the request DCI for retransmission of the dropped HARQ-ACK and may not use the resource for transmission of the HARQ-ACK to the PDSCH scheduled in the request DCI (refer to FIG. 6). In this case, the UE may control not to transmit (or, do not report or drop) the HARQ-ACK for the PDSCH newly scheduled in the request DCI.

FIG. 6 illustrates a case where the HARQ-ACK #1 (or PUCCH resource #1) corresponding to the PDSCH #1 and the HARQ-ACK #2 (or PUCCH resource #2) corresponding to the PDSCH #2 collide with another UL transmission (for example, a URLLC PUCCH resource #0) having a high priority and are dropped. Here, a case where the PUCCH resource #1 and the PUCCH resource #2 are the same PUCCH resource (or, PUCCH resources configured in the same slot) is illustrated.

FIG. 6 illustrates a case where the request DCI is transmitted after the HARQ-ACKs #1 and #2 are dropped. Furthermore, a case where the PDSCH #3 is scheduled by the request DCI is illustrated.

The UE performs control to retransmit the HARQ-ACKs #1 and #2 using the resource (here, the PUCCH resource #3) designated by the request DCI. Meanwhile, the HARQ-ACK #3 for the PDSCH #3 scheduled by the request DCI is controlled not to be transmitted in the PUCCH resource #3.

That is, the UE performs control so as not to map or multiplex the HARQ-ACK for the PDSCH scheduled by the request DCI and the HARQ-ACK to be retransmitted to the same resource (here, the PUCCH resource #3). The HARQ-ACK #3 may be controlled to be transmitted by other resources, or may be controlled not to be transmitted itself.

The resource (here, the PUCCH resource #3) designated by the request DCI may be determined on the basis of at least one of the K1 and the PRI field included in the request DCI. Further, the HARQ-ACK bit (or HARQ-ACK payload) transmitted on the PUCCH resource #3 may be determined in consideration of the dropped HARQ-ACK or the original HARQ-ACK (without considering the HARQ-ACK #3).

The PDSCH #3 scheduled by the request DCI or the HARQ-ACK #3 for the PDSCH #3 may be a PDSCH or a HARQ-ACK with low priority. That is, the priority configured to the PDSCH scheduled by the request DCI or the HARQ-ACK for the PDSCH may be limited (for example, limited to low). As a result, it is possible to suppress that the HARQ-ACK having a high priority is not transmitted or delayed.

<Option 2-2>

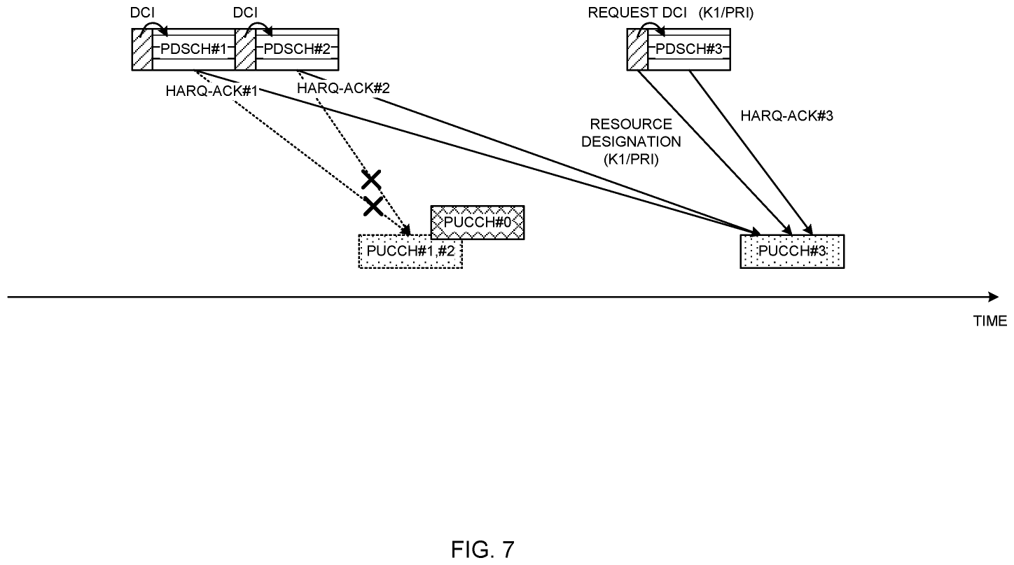

The UE may use the resource designated by the request DCI for retransmission of the dropped HARQ-ACK and transmission of the HARQ-ACK to the PDSCH scheduled in the request DCI (refer to FIG. 7). In this case, the UE may perform control such that the HARQ-ACK for the PDSCH newly scheduled in the request DCI and the HARQ-ACK to be retransmitted are included in the same HARQ-ACK codebook and transmitted.

FIG. 7 illustrates a case where the HARQ-ACK #1 (or PUCCH resource #1) corresponding to the PDSCH #1 and the HARQ-ACK #2 (or PUCCH resource #2) corresponding to the PDSCH #2 collide with another UL transmission (for example, a URLLC PUCCH resource #0) having a high priority and are dropped. Here, a case where the PUCCH resource #1 and the PUCCH resource #2 are the same PUCCH resource (or, PUCCH resources configured in the same slot) is illustrated.

FIG. 7 illustrates a case where the request DCI is transmitted after the HARQ-ACKs #1 and #2 are dropped. Furthermore, a case where the PDSCH #3 is scheduled by the request DCI is illustrated.

The UE performs control to perform retransmission of HARQ-ACKs #1 and #2 and transmission of HARQ-ACK #3 by using a resource (here, the PUCCH resource #3) designated by the request DCI. That is, the UE performs control to map or multiplex the HARQ-ACK for the PDSCH scheduled in the request DCI and the HARQ-ACK to be retransmitted to the same resource (here, the PUCCH resource #3).

The PDSCH #3 scheduled by the request DCI or the HARQ-ACK #3 for the PDSCH #3 may be a PDSCH or a HARQ-ACK with low priority. That is, the priority configured to the PDSCH scheduled by the request DCI or the HARQ-ACK for the PDSCH may be limited (for example, limited to low). As a result, priorities of HARQ-ACKs to be mapped or multiplexed on the same resource can be matched.

<Determination of HARQ-ACK to be Retransmitted>

The UE may determine, based on at least one of the option 1-1 to the option 1-3 in the first aspect, HARQ-ACK (for example, the dropped second HARQ-ACK) that performs retransmission based on the request DCI. That is, the UE may apply the option 2-1 or 2-2 and at least one of the option 1-1 to the option 1-3 of the first aspect in combination.

(Third Aspect)

In a third aspect, a case where a retransmission instruction (or request/trigger) of the HARQ-ACK is controlled using the UL data (for example, UL-SCH) or the DCI in which the PUSCH is not scheduled will be described. In the following description, a case where the PUSCH is scheduled by the DCI, but the UL data (PUSCH) is not transmitted (or, the schedule) will be described as an example.

When receiving a request DCI (or PDCCH) instructing retransmission of a given HARQ-ACK, the UE may control to retransmit (or retransmission, feedback, transmission) the given HARQ-ACK on the basis of the request DCI. The given HARQ-ACK may be a HARQ-ACK that has not been transmitted due to a collision with another UL transmission (for example, dropped or transmission stalled).

The request DCI may be DCI that does not schedule the UL data (for example, UL-SCH). The request DCI may be UE specific (for example, specific or dedicated), and for example, at least one of the DCI format 0_1 and the DCI format 0_2 may be used. Further, in addition to the configuration in which the UL data is not scheduled (or, in place of the configuration in which the UL data is not scheduled,), the request DCI may have a configuration in which the channel state information reference signal (for example, CSI-RS)/the channel state information report (for example, A-CSI report) is not scheduled/instructed.

The UE may determine whether the received DCI is the request DCI based on a given field included in the DCI. For example, it may be configured such that a field (for example, requestHarqReTx) about a retransmission request of the HARQ-ACK is configured to DCI, and in a case where a bit of the field is “1”, the request DCI functions, and in a case where the bit is “0”, the request DCI does not function. Alternatively, notification of whether or not the received DCI is the request DCI may be provided using another field. Alternatively, notification of whether or not the received DCI is the request DCI may be provided by using the RNTI applied to the DCI.

When receiving the request DCI, the UE may retransmit a given HARQ-ACK using a given resource. The resource used for retransmission of the HARQ-ACK may be a PUSCH scheduled or configured in the request DCI. The resource may be read as interchangeable with a PUSCH resource.

The PUSCH resource used for retransmission of the HARQ-ACK may be determined on the basis of at least one of a time allocation field and a frequency allocation field included in the request DCI. Further, the retransmitted HARQ-ACK may be mapped to the PUSCH resource, and the UL data/A-CSI/SRS may not be mapped to the PUSCH resource.

For example, it is assumed that a first resource corresponding to a first HARQ-ACK collides with a second resource corresponding to a second HARQ-ACK having a lower priority than the first HARQ-ACK.

The first HARQ-ACK corresponds to a first PDSCH scheduled in the first DCI, and the first resource may be designated by the first DCI (and higher layer signaling). The second HARQ-ACK corresponds to a second PDSCH scheduled in the second DCI, and the second resource may be designated by the second DCI (and higher layer signaling). Notification of the priority of the first HARQ-ACK may be provided in the first DCI, and notification of the priority of the second HARQ-ACK may be provided in the second DCI.

In such a case, the UE may control to transmit the first HARQ-ACK by using the first resource and not transmit the second HARQ-ACK (or, the HARQ-ACK transmission using the second resource is not performed). When receiving a request DCI (for example, the third DCI) instructing retransmission of the HARQ-ACK, the UE may perform control to transmit the second HARQ-ACK using a resource (for example, the PUSCH) designated by the request DCI.

Note that there may be a plurality of dropped HARQ-ACKs. The UE may determine, based on at least one of the option 1-1 to the option 1-3 in the first aspect, HARQ-ACK (for example, the dropped second HARQ-ACK) that performs retransmission based on the request DCI. For example, in Option 1-1 to Option 1-3 of the first aspect, the resource configured in the request DCI may be replaced from the PUCCH resource to the PUSCH resource.

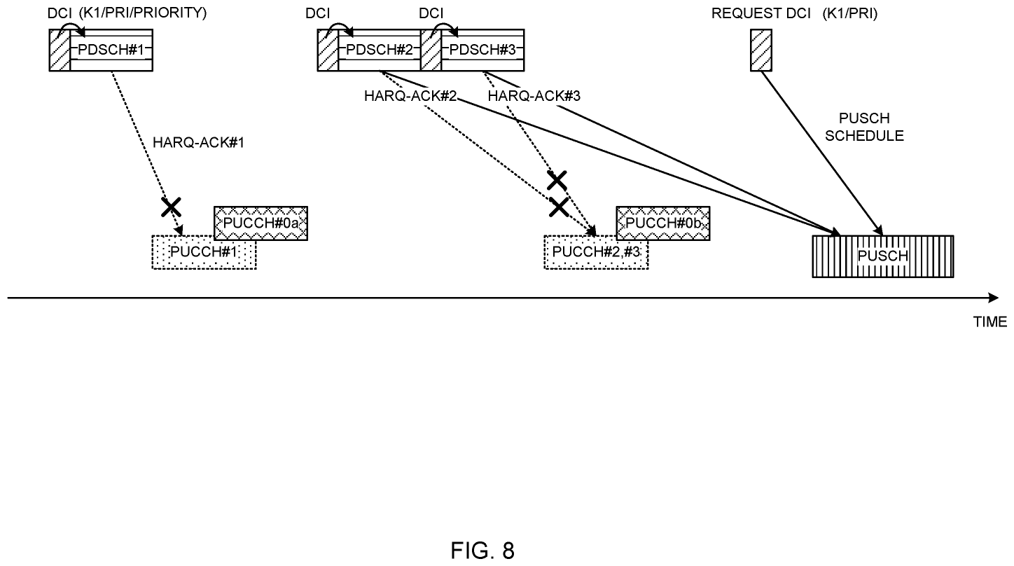

FIG. 8 illustrates an example of a case where the option 1-2 of the first aspect is applied, and the retransmission of the HARQ-ACK is performed by using the PUSCH resource. That is, FIG. 8 illustrates a case where the UE performs control to feed back (for example, retransmission) the HARQ-ACK dropped most recently (for example, latest) on the basis of the request DCI.

FIG. 8 illustrates a case where the HARQ-ACK #1 (or PUCCH resource #1) corresponding to the PDSCH #1 collides with another UL transmission (for example, the URLLC PUCCH resource #0a) having a high priority and is dropped.

In addition, a case where the HARQ-ACK #2 (or PUCCH resource #2) corresponding to the PDSCH #2 and the HARQ-ACK #3 (or PUCCH resource #3) corresponding to the PDSCH #3 collide with another UL transmission (for example, the URLLC PUCCH resource #0b) having a high priority and are dropped is illustrated. Here, a case where the PUCCH resource #2 and the PUCCH resource #3 are the same PUCCH resource (or, PUCCH resources configured in the same slot) is illustrated.

FIG. 8 illustrates a case where the request DCI is transmitted after the HARQ-ACKs #2 and #3 are dropped. That is, after the HARQ-ACK #1 is dropped, the HARQ-ACKs #2 and #3 are dropped before the request DCI is transmitted.

As described above, when the UE receives the request DCI, in a case where there is a plurality of dropped HARQ-ACKs, control may be performed such that the last dropped HARQ-ACK (or, the HARQ-ACK corresponding to the last PUCCH resource that has not been used for transmission) is retransmitted.

The HARQ-ACK to be retransmitted may be determined in units of PUCCH resources. That is, when the HARQ-ACKs corresponding to the same PUCCH resource (or, PUCCH resources configured in the same slot) are dropped (HARQ-ACKs #2 and #3 in FIG. 8), the plurality of HARQ-ACKs may be controlled to be retransmitted.

Here, since the HARQ-ACKs #2 and #3 correspond to the last dropped PUCCH resource, the UE may perform control to retransmit the HARQ-ACKs #2 and #3 using the PUSCH resource designated by the request DCI. The resource (for example, here, a PUSCH resource) designated by the request DCI may be determined on the basis of the allocation information of the PUSCH included in the request DCI.

In a case where the option 1-2 is used, it is possible to flexibly control the HARQ-ACK to perform retransmission on the basis of the transmission timing of the request DCI. As a result, an increase in the overhead of the retransmitted HARQ-ACK can be suppressed, and a decrease in the throughput can be suppressed.

(Fourth Aspect)

In a fourth aspect, a case where a retransmission instruction (or request/trigger) of the HARQ-ACK is controlled using the DCI for scheduling the UL data (for example, UL-SCH) will be described. In the following description, a case where UL data transmitted by the PUSCH is scheduled by the DCI will be described as an example.

When receiving a request DCI (or PDCCH) instructing retransmission of a given HARQ-ACK, the UE may control to retransmit (or retransmission, feedback, transmission) the given HARQ-ACK on the basis of the request DCI. The given HARQ-ACK may be a HARQ-ACK that has not been transmitted due to a collision with another UL transmission (for example, dropped or transmission stalled).

The request DCI may be DCI for scheduling UL data (for example, UL-SCH). The request DCI may be UE specific (for example, specific or dedicated), and for example, at least one of the DCI format 0_1 and the DCI format 0_2 may be used. In addition, the request DCI may be configured to schedule/instruct the channel state information reference signal (for example, CSI-RS)/channel state information report (for example, A-CSI report) in addition to the configuration to schedule the UL data (or, in place of the configuration for scheduling the UL data,).

The UE may determine whether the received DCI is the request DCI based on a given field included in the DCI. For example, it may be configured such that a field (for example, requestHarqReTx) about a retransmission request of the HARQ-ACK is configured to DCI, and in a case where a bit of the field is “1”, the request DCI functions, and in a case where the bit is “0”, the request DCI does not function. Alternatively, notification of whether or not the received DCI is the request DCI may be provided using another field. Alternatively, notification of whether or not the received DCI is the request DCI may be provided by using the RNTI applied to the DCI.

When receiving the request DCI, the UE may retransmit a given HARQ-ACK using a given resource. The resource used for retransmission of the HARQ-ACK may be a PUSCH scheduled or configured in the request DCI. The resource may be read as interchangeable with a PUSCH resource.

The PUSCH resource used for retransmission of the HARQ-ACK may be determined on the basis of at least one of a time allocation field and a frequency allocation field included in the request DCI. Further, retransmitted HARQ-ACK and UL data/A-CSI/SRS may be mapped to the PUSCH resource.

For example, it is assumed that a first resource corresponding to a first HARQ-ACK collides with a second resource corresponding to a second HARQ-ACK having a lower priority than the first HARQ-ACK.

The first HARQ-ACK corresponds to a first PDSCH scheduled in the first DCI, and the first resource may be designated by the first DCI (and higher layer signaling). The second HARQ-ACK corresponds to a second PDSCH scheduled in the second DCI, and the second resource may be designated by the second DCI (and higher layer signaling). Notification of the priority of the first HARQ-ACK may be provided in the first DCI, and notification of the priority of the second HARQ-ACK may be provided in the second DCI.

In such a case, the UE may control to transmit the first HARQ-ACK by using the first resource and not transmit the second HARQ-ACK (or, the HARQ-ACK transmission using the second resource is not performed). When receiving a request DCI (for example, the third DCI) instructing retransmission of the HARQ-ACK, the UE may perform control to transmit the second HARQ-ACK using a resource (for example, the PUSCH) designated by the request DCI.

Note that there may be a plurality of dropped HARQ-ACKs. The UE may determine, based on at least one of the option 1-1 to the option 1-3 in the first aspect, HARQ-ACK (for example, the dropped second HARQ-ACK) that performs retransmission based on the request DCI. For example, in Option 1-1 to Option 1-3 of the first aspect, the resource configured in the request DCI may be replaced from the PUCCH resource to the PUSCH resource.

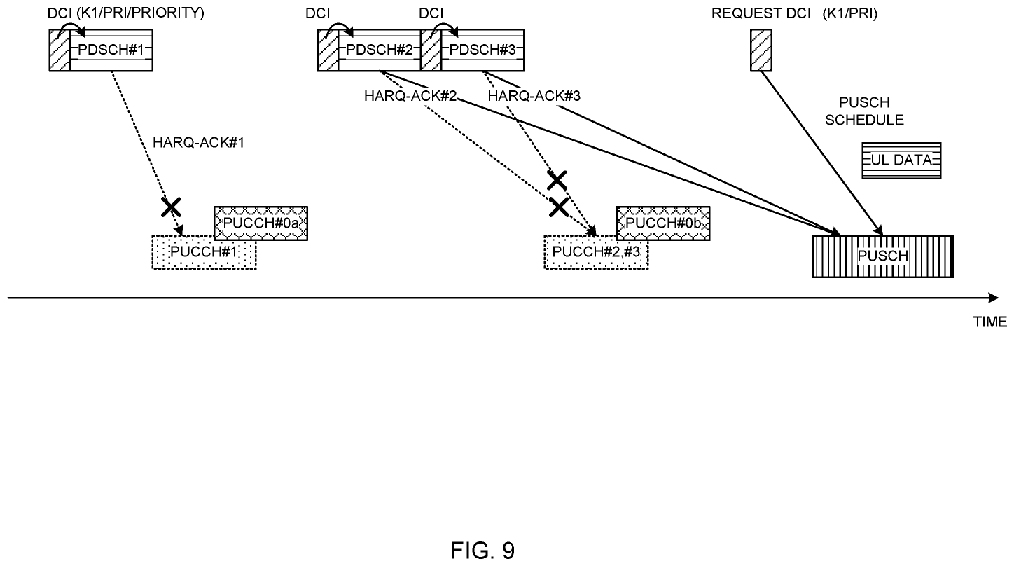

FIG. 9 illustrates an example of a case where the option 1-2 of the first aspect is applied, and the retransmission of the HARQ-ACK is performed by using the PUSCH resource. That is, FIG. 9 illustrates a case where the UE performs control to feed back (for example, retransmission) the HARQ-ACK dropped most recently (for example, latest) on the basis of the request DCI.

FIG. 9 illustrates a case where the HARQ-ACK #1 (or PUCCH resource #1) corresponding to the PDSCH #1 collides with another UL transmission (for example, the URLLC PUCCH resource #0a) having a high priority and is dropped.

In addition, a case where the HARQ-ACK #2 (or PUCCH resource #2) corresponding to the PDSCH #2 and the HARQ-ACK #3 (or PUCCH resource #3) corresponding to the PDSCH #3 collide with another UL transmission (for example, the URLLC PUCCH resource #0b) having a high priority and are dropped is illustrated. Here, a case where the PUCCH resource #2 and the PUCCH resource #3 are the same PUCCH resource (or, PUCCH resources configured in the same slot) is illustrated.

FIG. 9 illustrates a case where the request DCI is transmitted after the HARQ-ACKs #2 and #3 are dropped. That is, after the HARQ-ACK #1 is dropped, the HARQ-ACKs #2 and #3 are dropped before the request DCI is transmitted.

As described above, when the UE receives the request DCI, in a case where there is a plurality of dropped HARQ-ACKs, control may be performed such that the last dropped HARQ-ACK (or, the HARQ-ACK corresponding to the last PUCCH resource that has not been used for transmission) is retransmitted.

The HARQ-ACK to be retransmitted may be determined in units of PUCCH resources. That is, when the HARQ-ACKs corresponding to the same PUCCH resource (or, PUCCH resources configured in the same slot) are dropped (HARQ-ACKs #2 and #3 in FIG. 9), the plurality of HARQ-ACKs may be controlled to be retransmitted.

Here, since the HARQ-ACKs #2 and #3 correspond to the last dropped PUCCH resource, the UE may perform control to retransmit the HARQ-ACKs #2 and #3 using the PUSCH resource designated by the request DCI. The resource (for example, here, a PUSCH resource) designated by the request DCI may be determined on the basis of the allocation information of the PUSCH included in the request DCI.

Here, the UE may map or multiplex the UL data scheduled by the request DCI and the HARQ-ACKs #2 and #3 to the PUSCH resource designated by the request DCI.

In a case where the option 1-4 is used, it is possible to flexibly control the HARQ-ACK to perform retransmission on the basis of the transmission timing of the request DCI. As a result, an increase in the overhead of the retransmitted HARQ-ACK can be suppressed, and a decrease in the throughput can be suppressed.

(Variations)

In the first to fourth aspects, the case where the HARQ-ACK not transmitted by the UE (or dropped) is retransmitted has been described, but the present invention is not limited thereto. When the base station cannot receive the HARQ-ACK even if the UE transmits the HARQ-ACK, the base station may instruct retransmission of the HARQ-ACK using the request DCI. In this case, the UE may resend the HARQ-ACK that has made the transmission.

In the first to fourth aspects, the retransmission of the HARQ-ACK is instructed using the DCI used for the scheduling of the DL transmission or the UL transmission, but the present invention is not limited thereto. For example, retransmission of the HARQ-ACK may be instructed using DCI not used for scheduling the DL transmission or UL transmission.

In addition, the base station may notify the UE of the HARQ-ACK corresponding to the HARQ-ACK process number/CC index for performing retransmission using a given field of the request DCI. The HARQ-ACK may be a HARQ-ACK bit for the PDSCH. The given field may be a new field including given bits (x bits).

Alternatively, the given field may be used by replacing an existing field (for example, at least one of a TDRA field, a TDRA table, and a field for a HARQ-ACK process number) defined in Rel. 15. The replacement of the existing field may be configured in higher layer signaling.

Furthermore, in the first to fourth aspects, a case where retransmission is performed for a HARQ-ACK having a low priority (for example, low) has been described, but the present invention is not limited thereto. The retransmission may be performed for the HARQ-ACK having a high priority (for example, high). Alternatively, the HARQ-ACK to be retransmitted in the request DCI may be limited to the HARQ-ACK having a low priority.

When retransmission of the HARQ-ACK is instructed regardless of the priority of the HARQ-ACK, retransmission of the HARQ-ACK of one of the priorities may be instructed for each request DCI. The UE may determine which priority of retransmission is instructed based on the request DCI.

In addition, in the first to fourth aspects, whether or not to apply the retransmission control or the retransmission operation of the given HARQ-ACK may be provided in notification or configured by higher layer signaling from the base station to the UE. In this case, retransmission control of a given HARQ-ACK may be supported for a given UE, and retransmission control of a given HARQ-ACK may not be supported for another UE. For example, the presence or absence of support of retransmission control of a given HARQ-ACK may be controlled for each UE on the basis of UE capability/higher layer signaling.

(Radio Communication System)

Hereinafter, a configuration of a radio communication system according to one embodiment of the present disclosure will be described. In this radio communication system, communication is performed using one or a combination of the radio communication methods according to the embodiments of the present disclosure.

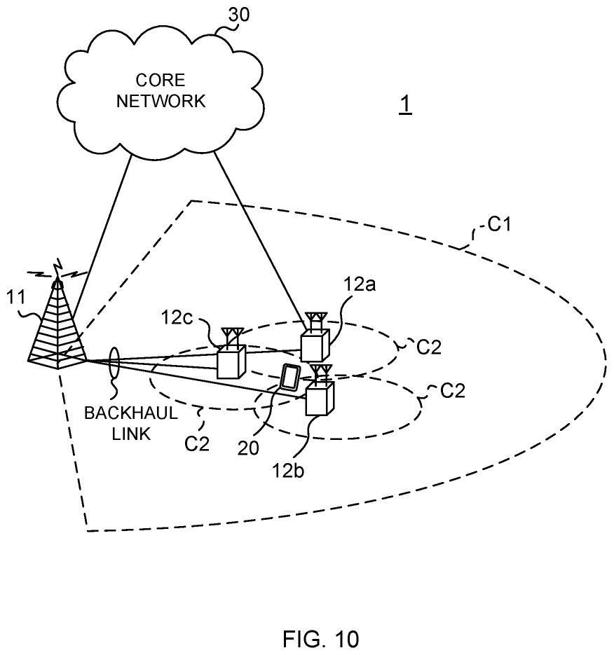

FIG. 10 is a diagram illustrating an example of a schematic configuration of the radio communication system according to one embodiment. A radio communication system 1 may be a system that implements communication using long term evolution (LTE), 5th generation mobile communication system New Radio (5G NR), and the like drafted as the specification by third generation partnership project (3GPP).

Further, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is a MN, and an LTE (E-UTRA) base station (eNB) is a SN.

The radio communication system 1 may support dual connectivity between a plurality of base stations in the same RAT (for example, dual connectivity in which both MN and SN are NR base stations (gNB) (NR-NR dual connectivity (NN-DC)).

The radio communication system 1 may include a base station 11 that forms a macro cell C1 with a relatively wide coverage, and base stations 12 (12a to 12c) that are arranged within the macro cell C1 and that form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as “base stations 10” in a case where these are not distinguished from each other.

The user terminal 20 may be connected to at least one of the plurality of base stations 10. The user terminal 20 may use at least one of carrier aggregation (CA) using a plurality of component carriers (CC) and dual connectivity (DC).

Each CC may be included in at least one of a frequency range 1 (FR1) or a second frequency range 2 (FR2). The macro cell C1 may be included in FR1, and the small cell C2 may be included in FR2. For example, FR1 may be a frequency range of 6 GHz or less (sub-6 GHz), and FR2 may be a frequency range higher than 24 GHz (above-24 GHz). Note that the frequency ranges, definitions, and the like of the FR 1 and FR 2 are not limited thereto, and, for example, the FR 1 may correspond to a frequency range higher than the FR 2.

Further, the user terminal 20 may perform communication in each CC using at least one of time division duplex (TDD) and frequency division duplex (FDD).

The plurality of base stations 10 may be connected to each other by wire (for example, an optical fiber or an X2 interface in compliance with common public radio interface (CPRI)) or by radio (for example, NR communication). For example, in a case where the NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of an evolved packet core (EPC), a 5G core network (5GCN), a next generation core (NGC), and the like.

The user terminal 20 may be a terminal corresponding to at least one of communication methods such as LTE, LTE-A, or 5G.

In the radio communication system 1, a radio access method based on orthogonal frequency division multiplexing (OFDM) may be used. For example, in at least one of downlink (DL) and uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), or the like may be used.

The radio access method may be referred to as a waveform. Note that in the radio communication system 1, another radio access method (for example, another single carrier transmission method or another multi-carrier transmission method) may be used as the UL and DL radio access method.

In the radio communication system 1, as a downlink channel, a physical downlink shared channel (PDSCH), a physical broadcast channel (PBCH), a physical downlink control channel (PDCCH), or the like shared by the user terminals 20 may be used.

Further, in the radio communication system 1, as an uplink channel, a physical uplink shared channel (PUSCH), a physical uplink control channel (PUCCH), a physical random access channel (PRACH), or the like shared by the user terminals 20 may be used.

The PDSCH transmits user data, higher layer control information, a system information block (SIB), and the like. The PUSCH may transmit the user data, higher layer control information, and the like. Further, the PBCH may transmit a master information block (MIB).

The PDCCH may transmit lower layer control information. The lower layer control information may include, for example, downlink control information (DCI) including scheduling information of at least one of the PDSCH and the PUSCH.

Note that DCI that schedules the PDSCH may be referred to as DL assignment, DL DCI, or the like, and DCI that schedules the PUSCH may be referred to as UL grant, UL DCI, or the like. Note that the PDSCH may be read as interchangeable with DL data, and the PUSCH may be read as interchangeable with UL data.

A control resource set (CORESET) and a search space may be used to detect the PDCCH. The CORESET corresponds to a resource that searches for DCI. The search space corresponds to a search area and a search method for PDCCH candidates. One CORESET may be associated with one or more search spaces. The UE may monitor the CORESET related to a given search space on the basis of search space configuration.

One search space may correspond to a PDCCH candidate corresponding to one or a plurality of aggregation levels. One or more search spaces may be referred to as a search space set. Note that “search space”, “search space set”, “search space configuration”, “search space set configuration”, “CORESET”, “CORESET configuration”, and the like in the present disclosure may be read as interchangeable with each other.

Uplink control information (UCI) including at least one of channel state information (CSI), delivery confirmation information (which may be referred to as, for example, hybrid automatic repeat request acknowledgement (HARQ-ACK), ACK/NACK, or the like), scheduling request (SR), and the like may be transmitted by the PUCCH. By means of the PRACH, a random access preamble for establishing a connection with a cell may be transmitted.

Note that in the present disclosure, downlink, uplink, and the like may be expressed without “link”. Further, various channels may be expressed without adding “physical” at the beginning thereof.

In the radio communication system 1, a synchronization signal (SS), a downlink reference signal (DL-RS), and the like may be transmitted. In the radio communication systems 1, a cell-specific reference signal (CRS), a channel state information reference signal (CSI-RS), a demodulation reference signal (DMRS), a positioning reference signal (PRS), a phase tracking reference signal (PTRS), and the like may be transmitted as the DL-RS.

The synchronization signal may be, for example, at least one of a primary synchronization signal (PSS) and a secondary synchronization signal (SSS). A signal block including the SS (PSS or SSS) and the PBCH (and the DMRS for the PBCH) may be referred to as an SS/PBCH block, an SS block (SSB), or the like. Note that the SS, the SSB, or the like may also be referred to as a reference signal.

Further, in the radio communication system 1, a sounding reference signal (SRS), the demodulation reference signal (DMRS), and the like may be transmitted as an uplink reference signal (UL-RS). Note that the DMRS may be referred to as a “user terminal-specific reference signal (UE-specific Reference Signal).”

(Base Station)

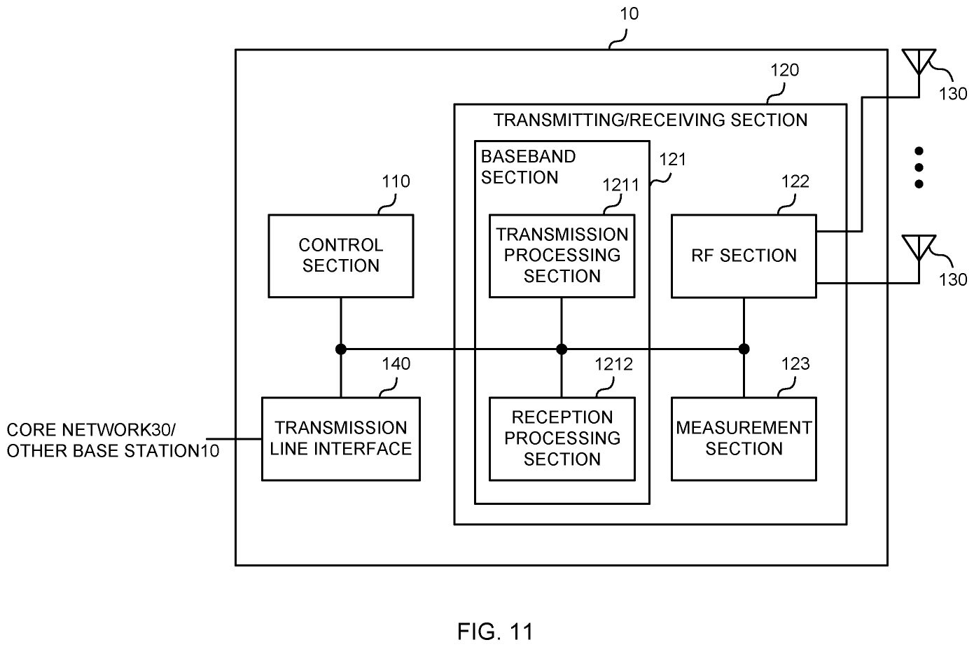

FIG. 11 is a diagram illustrating an example of a configuration of the base station according to one embodiment. The base station 10 includes a control section 110, a transmission/reception section 120, a transmission/reception antenna 130, and a transmission line interface 140. Note that one or more each of the control sections 110, the transmission/reception sections 120, the transmission/reception antennas 130, and the transmission line interfaces 140 may be included.

Note that this example mainly describes functional blocks of characteristic parts in the present embodiment, and it may be assumed that the base station 10 also includes other functional blocks necessary for radio communication. A part of processing of each section described below may be omitted.

The control section 110 controls the entire base station 10. The control section 110 can include a controller, a control circuit, and the like that are described on the basis of common recognition in the technical field related to the present disclosure.

The control section 110 may control signal generation, scheduling (for example, resource allocation, mapping), and the like. The control section 110 may control transmission/reception, measurement, and the like using the transmission/reception section 120, the transmission/reception antenna 130, and the transmission line interface 140. The control section 110 may generate data to be transmitted as a signal, control information, a sequence, and the like, and may forward the data, the control information, the sequence, and the like to the transmission/reception section 120. The control section 110 may perform call processing (such as configuration or release) of a communication channel, state management of the base station 10, management of a radio resource, and the like.

The transmission/reception section 120 may include a baseband section 121, a radio frequency (RF) section 122, and a measurement section 123. The baseband section 121 may include a transmission processing section 1211 and a reception processing section 1212. The transmission/reception section 120 can include a transmission section/reception section, an RF circuit, a baseband circuit, a filter, a phase shifter, a measurement circuit, a transmission/reception circuit, and the like that are described on the basis of common recognition in the technical field related to the present disclosure.

The transmission/reception section 120 may be formed as an integrated transmission/reception section, or may include a transmission section and a reception section. The transmission section may include the transmission processing section 1211 and the RF section 122. The reception section may include the reception processing section 1212, the RF section 122, and the measurement section 123.

The transmission/reception antenna 130 can include an antenna described on the basis of common recognition in the technical field related to the present disclosure, for example, an array antenna or the like.

The transmission/reception section 120 may transmit the above-described downlink channel, synchronization signal, downlink reference signal, and the like. The transmission/reception section 120 may receive the above-described uplink channel, uplink reference signal, and the like.

The transmission/reception section 120 may form at least one of a transmission beam and a reception beam by using digital beam forming (for example, precoding), analog beam forming (for example, phase rotation), or the like.

The transmission/reception section 120 (transmission processing section 1211) may perform packet data convergence protocol (PDCP) layer processing, radio link control (RLC) layer processing (for example, RLC retransmission control), medium access control (MAC) layer processing (for example, HARQ retransmission control), and the like, for example, on data, control information, and the like acquired from the control section 110, to generate a bit string to be transmitted.

The transmission/reception section 120 (transmission processing section 1211) may perform transmission processing such as channel encoding (which may include error correction encoding), modulation, mapping, filtering processing, discrete Fourier transform (DFT) processing (if necessary), inverse fast Fourier transform (IFFT) processing, precoding, or digital-analog conversion on the bit string to be transmitted, to output a baseband signal.

The transmission/reception section 120 (RF section 122) may perform modulation to a radio frequency range, filtering processing, amplification, and the like on the baseband signal, to transmit a signal in the radio frequency range via the transmission/reception antenna 130.

Meanwhile, the transmission/reception section 120 (RF section 122) may perform amplification, filtering processing, demodulation to a baseband signal, and the like on the signal in the radio frequency range received by the transmission/reception antenna 130.

The transmission/reception section 120 (reception processing section 1212) may apply reception processing such as analog-digital conversion, fast Fourier transform (FFT) processing, inverse discrete Fourier transform (IDFT) processing (if necessary), filtering processing, demapping, demodulation, decoding (which may include error correction decoding), MAC layer processing, RLC layer processing, or PDCP layer processing on the acquired baseband signal to acquire user data and the like.

The transmission/reception section 120 (measurement section 123) may perform measurement on the received signal. For example, the measurement section 123 may perform radio resource management (RRM), channel state information (CSI) measurement, and the like based on the received signal. The measurement section 123 may measure received power (for example, reference signal received power (RSRP)), received quality (for example, reference signal received quality (RSRQ), a signal to interference plus noise ratio (SINR), a signal to noise ratio (SNR)), signal strength (for example, received signal strength indicator (RSSI)), propagation path information (for example, CSI), and the like. The measurement result may be output to the control section 110.

The transmission line interface 140 may perform transmission/reception (backhaul signaling) of a signal to/from apparatuses, other base stations 10, and the like included in the core network 30, and may perform acquisition, transmission, and the like of user data (user plane data), control plane data, and the like for the user terminal 20.

Note that the transmission section and the reception section of the base station 10 in the present disclosure may include at least one of the transmission/reception section 120, the transmission/reception antenna 130, and the transmission line interface 140.

The transmission/reception section 120 may receive the UL transmission when the delivery acknowledgement signal (HARQ-ACK) collides with another UL transmission. The transmission/reception section 120 may transmit downlink control information including information about retransmission of the HARQ-ACK.

The control section 110 may control reception of the HARQ-ACK to be retransmitted using a resource notification of which is provided by the downlink control information.

(User Terminal)

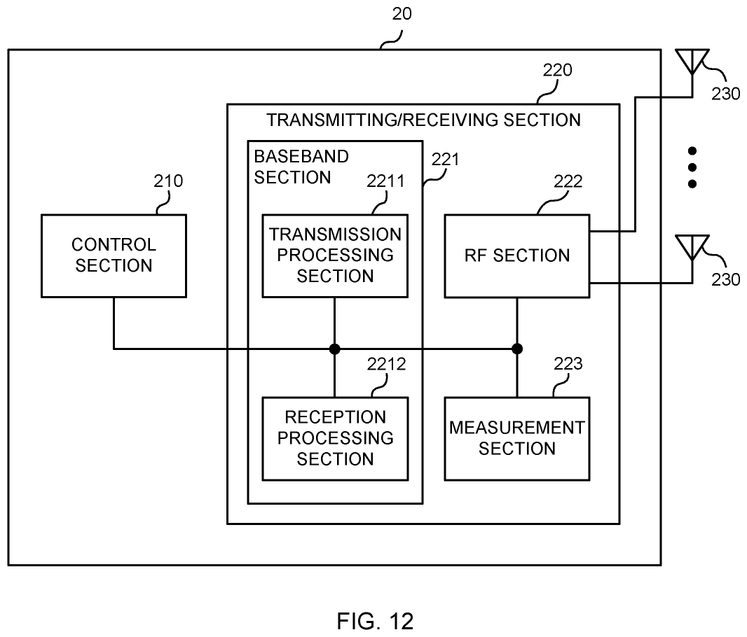

FIG. 12 is a diagram illustrating an example of a configuration of the user terminal according to one embodiment. The user terminal 20 includes a control section 210, a transmission/reception section 220, and a transmission/reception antenna 230. Note that, one or more each of the control sections 210, the transmission/reception sections 220, and the transmission/reception antennas 230 may be included.

Note that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can include a controller, a control circuit, and the like that are described on the basis of common recognition in the technical field related to the present disclosure.

The control section 210 may control signal generation, mapping, and the like. The control section 210 may control transmission/reception, measurement, and the like using the transmission/reception section 220 and the transmission/reception antenna 230. The control section 210 may generate data, control information, a sequence, and the like to be transmitted as signals, and may transfer the data, control information, sequence, and the like to the transmission/reception section 220.

The transmission/reception section 220 may include a baseband section 221, an RF section 222, and a measurement section 223. The baseband section 221 may include a transmission processing section 2211 and a reception processing section 2212. The transmission/reception section 220 can include a transmission section/reception section, an RF circuit, a baseband circuit, a filter, a phase shifter, a measurement circuit, a transmission/reception circuit, and the like that are described on the basis of common recognition in the technical field related to the present disclosure.

The transmission/reception section 220 may be formed as an integrated transmission/reception section, or may include a transmission section and a reception section. The transmission section may include the transmission processing section 2211 and the RF section 222. The reception section may include the reception processing section 2212, the RF section 222, and the measurement section 223.

The transmission/reception antenna 230 can include an antenna described on the basis of common recognition in the technical field related to the present disclosure, for example, an array antenna.

The transmission/reception section 220 may receive the above-described downlink channel, synchronization signal, downlink reference signal, and the like. The transmission/reception section 220 may transmit the above-described uplink channel, uplink reference signal, and the like.

The transmission/reception section 220 may form at least one of a transmission beam and a reception beam by using digital beam forming (for example, precoding), analog beam forming (for example, phase rotation), and the like.

The transmission/reception section 220 (transmission processing section 2211) may perform PDCP layer processing, RLC layer processing (for example, RLC retransmission control), MAC layer processing (for example, HARQ retransmission control), and the like on, for example, data, control information, and the like acquired from the control section 210, to generate a bit string to be transmitted.

The transmission/reception section 220 (transmission processing section 2211) may perform transmission processing such as channel encoding (which may include error correction encoding), modulation, mapping, filtering processing, DFT processing (if necessary), IFFT processing, precoding, or digital-analog conversion on the bit string to be transmitted, to output a baseband signal.

Note that, whether or not to apply DFT processing may be determined on the basis of configuration of transform precoding. When the transform precoding is enabled for a channel (for example, PUSCH), the transmission/reception section 220 (transmission processing section 2211) may perform DFT processing as the transmission processing to transmit the channel by using a DFT-s-OFDM waveform, and when not, DFT processing does not have to be performed as the transmission processing.

The transmission/reception section 220 (RF section 222) may perform modulation to a radio frequency range, filtering processing, amplification, and the like on the baseband signal, to transmit a signal in the radio frequency range via the transmission/reception antenna 230.

Meanwhile, the transmission/reception section 220 (RF section 222) may perform amplification, filtering processing, demodulation to a baseband signal, and the like on the signal in the radio frequency range received by the transmission/reception antenna 230.

The transmission/reception section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal, to acquire user data and the like.

The transmission/reception section 220 (measurement section 223) may perform measurement on the received signal. For example, the measurement section 223 may perform RRM measurement, CSI measurement, and the like based on the received signal. The measurement section 223 may measure received power (for example, RSRP), received quality (for example, RSRQ, SINR, or SNR), signal strength (for example, RSSI), propagation path information (for example, CSI), and the like. The measurement result may be output to the control section 210.

Note that the transmission section and the reception section of the user terminal 20 in the present disclosure may include at least one of the transmission/reception section 220 and the transmission/reception antenna 230.

When the delivery acknowledgement signal (HARQ-ACK) collides with another UL transmission, the transmission/reception section 220 may transmit the UL transmission. The transmission/reception section 220 may receive downlink control information including information about retransmission of HARQ-ACK.

The control section 210 may control retransmission of the HARQ-ACK using a resource notification of which is provided by the downlink control information.

The downlink control information may not indicate the schedule of the downlink shared channel.

When the downlink control information instructs the schedule of the downlink shared channel, the control section 210 may perform control so as not to transmit the HARQ-ACK for the downlink shared channel or to transmit the HARQ-ACK for the downlink shared channel by using a resource used for retransmission of the HARQ-ACK.

When the downlink control information instructs the schedule of the uplink shared channel, the control section 210 may control retransmission of the HARQ-ACK using the uplink shared channel.

(Hardware Configuration)

Note that the block diagrams that have been used to describe the above embodiments illustrate blocks in functional units. These functional blocks (components) may be implemented in arbitrary combinations of at least one of hardware and software. Further, the method for implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional block may be implemented by combining the one apparatus or the plurality of apparatuses with software.

Here, the functions include, but are not limited to, judging, determination, decision, calculation, computation, processing, derivation, investigation, search, confirmation, reception, transmission, output, access, solution, selection, choosing, establishment, comparison, assumption, expectation, deeming, broadcasting, notifying, communicating, forwarding, configuring, reconfiguring, allocating, mapping, assigning, and the like. For example, a functional block (component) that has a transmission function may be referred to as a transmission section (transmitting unit), a transmitter, and the like. In any case, as described above, the implementation method is not particularly limited.

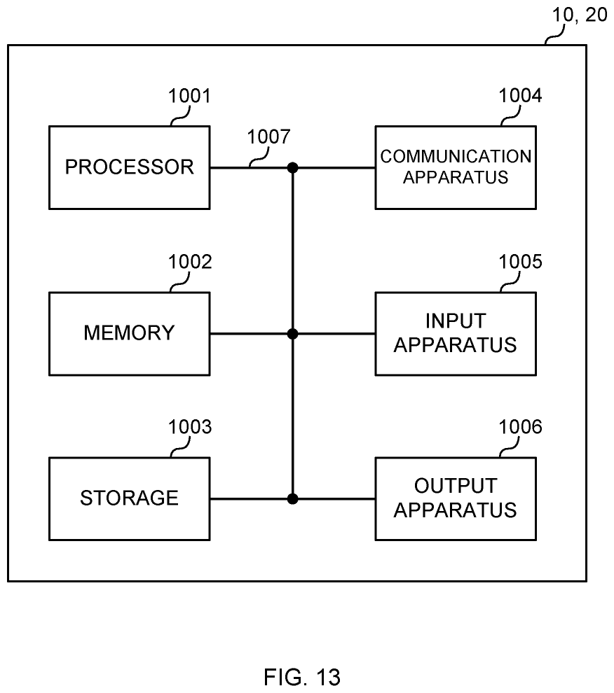

For example, the base station, the user terminal, and the like according to one embodiment of the present disclosure may function as a computer that executes the processing of the radio communication method of the present disclosure. FIG. 13 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, and a unit can be read as interchangeable with each other. The hardware configuration of the base station 10 and the user terminal 20 may be designed to include one or more of the apparatuses illustrated in the drawings, or may be designed not to include some apparatuses.

For example, although only one processor 1001 is illustrated, a plurality of processors may be provided. Further, the processing may be executed by one processor, or the processing may be executed by two or more processors simultaneously or sequentially, or using other methods. Note that the processor 1001 may be implemented with one or more chips.

Each function of the base station 10 and the user terminal 20 is implemented by, for example, reading given software (program) onto hardware such as the processor 1001 and the memory 1002, and by controlling the operation in the processor 1001, the communication in the communication apparatus 1004, and at least one of the reading or writing of data in the memory 1002 and the storage 1003.

The processor 1001 may control the whole computer by, for example, running an operating system. The processor 1001 may be configured by a central processing unit (CPU) including an interface with peripheral equipment, a control apparatus, an operation apparatus, a register, and the like. For example, at least a part of the above-described control section 110 (210), transmission/reception section 120 (220), and the like may be implemented by the processor 1001.

Furthermore, the processor 1001 reads programs (program codes), software modules, data, and the like from at least one of the storage 1003 and the communication apparatus 1004 into the memory 1002, and executes various processing according to these. As the program, a program that causes a computer to execute at least a part of the operation described in the above-described embodiment is used. For example, the control section 110 (210) may be implemented by control programs that are stored in the memory 1002 and that operate on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), or other appropriate storage media. The memory 1002 may be referred to as a register, a cache, a main memory (primary storage apparatus), and the like. The memory 1002 can store a program (program code), a software module, and the like executable for implementing the radio communication method according to one embodiment of the present disclosure.

The storage 1003 is a computer-readable recording medium, and may include, for example, at least one of a flexible disk, a floppy (registered trademark) disk, a magneto-optical disk (for example, a compact disc ROM (CD-ROM) and the like), a digital versatile disk, a Blu-ray (registered trademark) disk), a removable disk, a hard disk drive, a smart card, a flash memory device (for example, a card, a stick, or a key drive), a magnetic stripe, a database, a server, or other appropriate storage media. The storage 1003 may be referred to as “secondary storage apparatus.”

The communication apparatus 1004 is hardware (transmission/reception device) for performing inter-computer communication via at least one of a wired network and a wireless network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) and time division duplex (TDD). For example, the transmission/reception section 120 (220), the transmission/reception antenna 130 (230), and the like described above may be implemented by the communication apparatus 1004. The transmission/reception section 120 (220) may be implemented by physically or logically separating the transmission section 120a (220a) and the reception section 120b (220b) from each other.

The input apparatus 1005 is an input device for receiving input from the outside (for example, a keyboard, a mouse, a microphone, a switch, a button, a sensor, and the like). The output apparatus 1006 is an output device that performs output to the outside (for example, a display, a speaker, a light emitting diode (LED) lamp, or the like). Note that the input apparatus 1005 and the output apparatus 1006 may be provided in an integrated structure (for example, a touch panel).

Furthermore, apparatuses, including the processor 1001, the memory 1002, and the like are connected by the bus 1007 so as to communicate information. The bus 1007 may be formed with a single bus, or may be formed with buses that vary between apparatuses.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented with at least one of these pieces of hardware.

(Modifications)

Note that terms described in the present disclosure and terms necessary for understanding the present disclosure may be replaced with terms that have the same or similar meanings. For example, a channel, a symbol, and a signal (signal or signaling) may be read as interchangeable with each other. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may include one or more periods (frames) in the time domain. Each of the one or more periods (frames) included in the radio frame may be referred to as a subframe. Further, the subframe may include one or more slots in the time domain. The subframe may be a fixed time duration (for example, 1 ms) that is not dependent on numerology.

Here, the numerology may be a communication parameter used for at least one of transmission or reception of a given signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, specific windowing processing performed by a transceiver in the time domain, and the like.

The slot may include one or more symbols in the time domain (orthogonal frequency division multiplexing (OFDM) symbols, single carrier frequency division multiple access (SC-FDMA) symbols, and the like). Also, a slot may be a time unit based on numerology.

The slot may include a plurality of mini slots. Each mini slot may include one or more symbols in the time domain. Further, the mini slot may be referred to as a subslot. Each mini slot may include fewer symbols than the slot. A PDSCH (or PUSCH) transmitted in a time unit larger than the mini slot may be referred to as “PDSCH (PUSCH) mapping type A”. A PDSCH (or PUSCH) transmitted using the mini slot may be referred to as “PDSCH (PUSCH) mapping type B”.

A radio frame, a subframe, a slot, a mini slot and a symbol all represent the time unit in signal communication. The radio frame, the subframe, the slot, the mini slot, and the symbol may be called by other applicable names, respectively. Note that time units such as the frame, the subframe, the slot, the mini slot, and the symbol in the present disclosure may be read as interchangeable with each other.

For example, one subframe may be referred to as TTI, a plurality of consecutive subframes may be referred to as TTI, or one slot or one mini slot may be referred to as TTI. That is, at least one of the subframe and the TTI may be a subframe (1 ms) in the existing LTE, may be a period shorter than 1 ms (for example, one to thirteen symbols), or may be a period longer than 1 ms. Note that the unit to represent the TTI may be referred to as a “slot,” a “mini slot”, and the like, instead of a “subframe.”

Here, a TTI refers to the minimum time unit of scheduling in radio communication, for example. For example, in the LTE system, a base station performs scheduling to allocate radio resources (a frequency bandwidth, transmission power, and the like that can be used in each user terminal) to each user terminal in TTI units. Note that the definition of TTIs is not limited to this.

The TTI may be a transmission time unit such as a channel-coded data packet (transport block), a code block, a codeword, or the like, or may be a processing unit such as scheduling or link adaptation. Note that when TTI is given, a time interval (for example, the number of symbols) in which the transport blocks, the code blocks, the codewords, and the like are actually mapped may be shorter than TTI.

Note that, when one slot or one mini slot is referred to as a “TTI,” one or more TTIs (that is, one or multiple slots or one or more mini slots) may be the minimum time unit of scheduling. Also, the number of slots (the number of mini slots) to constitute this minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini slot, a subslot, a slot, or the like.

Note that a long TTI (for example, a normal TTI, a subframe, and the like) may be read as interchangeable with a TTI having a time duration exceeding 1 ms, and a short TTI (for example, a shortened TTI) may be read as interchangeable with a TTI having a TTI duration less than the TTI duration of a long TTI and not less than 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in the RB may be determined based on numerology.

In addition, the RB may include one or more symbols in the time domain, and may be one slot, one mini slot, one subframe or one TTI in length. One TTI, one subframe, and the like may each include one or more resource blocks.

Note that one or more RBs may be referred to as a physical resource block (PRB), a subcarrier group (SCG), a resource element group (REG), a PRB pair, an RB pair, and the like.

Furthermore, a resource block may include one or more resource elements (REs). For example, one RE may be a radio resource field of one subcarrier and one symbol.

A bandwidth part (BWP) (which may be referred to as a partial bandwidth or the like) may represent a subset of contiguous common resource blocks (RBs) for a given numerology in a given carrier. Here, the common RB may be specified by the index of the RB based on a common reference point of the carrier. A PRB may be defined in a given BWP and numbered within the BWP.

The BWP may include a BWP for UL (UL BWP) and a BWP for DL (DL BWP). For the UE, one or more BWPs may be configured within one carrier.

At least one of the configured BWPs may be active, and the UE need not expect to transmit or receive a given signal/channel outside the active BWP. Note that, a “cell”, a “carrier”, and the like in the present disclosure may be read as interchangeable with a BWP.

Note that the structures of radio frames, subframes, slots, mini slots, symbols, and the like described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

Furthermore, the information and parameters described in the present disclosure may be represented in absolute values, represented in relative values with respect to given values, or represented using other corresponding information. For example, a radio resource may be instructed by a given index.

Names used for, for example, parameters in the present disclosure are in no respect limitative. Further, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not restrictive names in any respect.

The information, signals, and the like described in the present disclosure may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Further, information, signals, and the like can be output in at least one of a direction from higher layers to lower layers and a direction from lower layers to higher layers. Information, signals and the like may be input and output via a plurality of network nodes.

The information, signals and the like that are input and/or output may be stored in a specific location (for example, in a memory), or may be managed using a management table. The information, signals, and the like to be input and output can be overwritten, updated, or appended. The output information, signals, and the like may be deleted. The information, signals and the like that are input may be transmitted to other apparatuses.

Notification of information may be performed not only by using the aspects/embodiments described in the present disclosure but also using another method. For example, the notification of information in the present disclosure may be performed by using physical layer signaling (for example, downlink control information (DCI) or uplink control information (UCI)), higher layer signaling (for example, radio resource control (RRC) signaling, broadcast information (master information block (MIB)), system information block (SIB), or the like), or medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message, and the like. Further, notification of the MAC signaling may be performed using, for example, an MAC control element (CE).

Also, reporting of given information (for example, reporting of information to the effect that “X holds”) does not necessarily have to be sent explicitly, and can be sent implicitly (for example, by not reporting this information, by reporting another information, and the like).

Decisions may be made in values represented by one bit (0 or 1), may be made in Boolean values that represent true or false, or may be made by comparing numerical values (for example, comparison against a given value).

Software, whether referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions, and the like.

Moreover, software, commands, information, and the like may be transmitted and received via communication media. For example, when software is transmitted from a website, a server, or another remote source by using at least one of a wired technology (coaxial cable, optical fiber cable, twisted pair, digital subscriber line (DSL), or the like) or a wireless technology (infrared rays, microwaves, and the like), at least one of the wired technology or the wireless technology is included within the definition of a transmission medium.

The terms “system” and “network” used in the present disclosure may be used interchangeably. The “network” may mean an apparatus (for example, a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (for example, three) cells. In a case where the base station accommodates a plurality of cells, the entire coverage area of the base station can be partitioned into a plurality of smaller areas, and each smaller area can provide communication services through a base station subsystem (for example, small base station for indoors (remote radio head (RRH))). The term “cell” or “sector” refers to a part or the whole of a coverage area of at least one of the base station or the base station subsystem that performs a communication service in this coverage.

In the present disclosure, the terms such as “mobile station (MS)”, “user terminal”, “user equipment (UE)”, and “terminal” can be used interchangeably.

A mobile station may be referred to as a subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

At least one of the base station and mobile station may be called as a transmission apparatus, a reception apparatus, a wireless communication apparatus, and the like. Note that at least one of the base station and the mobile station may be a device mounted on a moving object, a moving object itself, and the like. The moving object may be a transportation (for example, a car, an airplane, or the like), an unmanned moving object (for example, a drone, an autonomous car, or the like), or a (manned or unmanned) robot. Note that at least one of the base station and the mobile station also includes an apparatus that does not necessarily move during a communication operation. For example, at least one of the base station or the mobile station may be an Internet of Things (IoT) device such as a sensor.

Further, the base station in the present disclosure may be read as interchangeable with the user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. Further, terms such as “uplink” and “downlink” may be read as interchangeable with terms corresponding to communication between terminals (for example, “side”). For example, an uplink channel and a downlink channel may be read as interchangeable with a side channel.

Likewise, the user terminal in the present disclosure may be read as interchangeable with the base station. In this case, the base station 10 may be configured to have the functions of the user terminal 20 described above.

In the present disclosure, an operation performed by the base station may be performed by an upper node thereof in some cases. In a network including one or more network nodes with base stations, it is clear that various operations performed for communication with a terminal can be performed by a base station, one or more network nodes (examples of which include but are not limited to mobility management entity (MME) and serving-gateway (S-GW)) other than the base station, or a combination thereof.

The aspects/embodiments illustrated in the present disclosure may be used individually or in combinations, which may be switched depending on the mode of implementation. Further, the order of processing procedures, sequences, flowcharts, and the like of the aspects/embodiments described in the present disclosure may be re-ordered as long as there is no inconsistency. For example, although various methods have been illustrated in the present disclosure with various components of steps using exemplary orders, the specific orders that are illustrated herein are by no means limiting.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), future radio access (FRA), new radio access technology (RAT), new radio (NR), new radio access (NX), future generation radio access (FX), global system for mobile communications (GSM (registered trademark)), CDMA2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded based on these, and the like. Further, a plurality of systems may be combined and applied (for example, a combination of LTE or LTE-A and 5G, and the like).

The phrase “based on” as used in the present disclosure does not mean “based only on”, unless otherwise specified. In other words, the phrase “based on” means both “based only on” and “based at least on.”

Reference to elements with designations such as “first”, “second”, and the like as used in the present disclosure does not generally limit the number/quantity or order of these elements. These designations can be used in the present disclosure, as a convenient way of distinguishing between two or more elements. In this way, reference to the first and second elements does not imply that only two elements may be employed, or that the first element must precede the second element in some way.

The term “determining” as used in the present disclosure may encompass a wide variety of operations. For example, “determining” may be regarded as judging, calculating, computing, processing, deriving, investigating, looking up, search, inquiry (for example, looking up in a table, database, or another data structure), ascertaining, and the like.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory), and the like.

In addition, to “judge” and “determine” as used herein may be interpreted to mean making judgements and determinations related to resolving, selecting, choosing, establishing, comparing, and the like. In other words, to “judge” and “determine” as used herein may be interpreted to mean making judgements and determinations related to some operations.

In addition, “judge” and “determine” as used herein may be read as interchangeable with “assuming”, “expecting”, “considering”, or the like.

As used in the present disclosure, the terms “connected” and “coupled”, or any variation of these terms mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be read as interchangeable with “access”.

As used in the present disclosure, when two elements are connected, these elements may be considered “connected” or “coupled” to each other by using one or more electrical wires, cables, printed electrical connections, and the like, and, as a number of non-limiting and non-inclusive examples, by using electromagnetic energy having wavelengths in the radio frequency domain, the microwave region, and the optical (both visible and invisible) region, or the like.

In the present disclosure, the phrase “A and B are different” may mean “A and B are different from each other”. Note that the phrase may mean that “A and B are different from C”. The terms such as “separated”, “coupled”, and the like may be similarly interpreted as “different”.

When the terms such as “include”, “including”, and variations of these are used in the present disclosure, these terms are intended to be inclusive, in a manner similar to the way the term “comprising” is used. Furthermore, the term “or” as used in the present disclosure is intended to be not an exclusive-OR.

In the present disclosure, when articles, such as “a”, “an”, and “the” are added in English translation, the present disclosure may include the plural forms of nouns that follow these articles.

Now, although the invention according to the present disclosure has been described in detail above, it is obvious to a person skilled in the art that the invention according to the present disclosure is by no means limited to the embodiments described in the present disclosure. The invention according to the present disclosure can be embodied with various corrections and in various modified aspects, without departing from the spirit and scope of the invention defined on the basis of the description of claims. Consequently, the description of the present disclosure is provided only for the purpose of explaining examples, and should by no means be construed to limit the invention according to the present disclosure in any way.

1. A terminal comprising:
a transmission section that transmits, when a delivery acknowledgement signal (HARQ-ACK) collides with another UL transmission, the UL transmission;
a reception section that receives downlink control information including information related to retransmission of the HARQ-ACK; and
a control section that controls retransmission of the HARQ-ACK using a resource notified by the downlink control information.

2. The terminal according to claim 1, wherein the downlink control information does not indicate a schedule of a physical downlink shared channel.

3. The terminal according to claim 1, wherein when the downlink control information indicates a schedule of a downlink shared channel, the control section performs control so as not to transmit a HARQ-ACK for the physical downlink shared channel or so as to transmit a HARQ-ACK for the physical downlink shared channel by using the resource used for the retransmission of the HARQ-ACK.

4. The terminal according to claim 1, wherein when the downlink control information indicates a schedule of a physical uplink shared channel, the control section controls retransmission of the HARQ-ACK using the physical uplink shared channel.

5. A radio communication method of a terminal comprising:
transmitting, when a delivery acknowledgement signal (HARQ-ACK) collides with another UL transmission, the UL transmission;
receiving downlink control information including information related to retransmission of the HARQ-ACK; and
controlling retransmission of the HARQ-ACK using a resource notified by the downlink control information.

6. A base station comprising:
a reception section that receives, when a delivery acknowledgement signal (HARQ-ACK) collides with another UL transmission, the UL transmission;
a transmission section that transmits downlink control information including information related to retransmission of the HARQ-ACK; and
a control section that controls reception of the HARQ-ACK to be retransmitted using a resource notified by the downlink control information.
